(19) United States
(12) Patent Application Publication
(10) Pub. No.: US 2020/0229482 A1
(43) Pub. Date: Jul. 23, 2020

(54) VARIABLE INTENSITY CONTROLLER FOR A SHORT-TERM INTENSE PROCESS

(71) Applicant: SMARTWASH SOLUTIONS LLC, Salinas, CA (US)

(72) Inventors: Christopher Michael MCGINNIS, Salinas, CA (US); Eric Child WILHELMSEN, Freemont, CA (US); James M. BRENNAN, Pleasanton, CA (US)

(21) Appl. No.: 16/739,562

(22) Filed: Jan. 10, 2020

Related U.S. Application Data
(60) Provisional application No. 62/794,184, filed on Jan. 18, 2019.

(51) Int. Cl. A23N 12/02; B08B 3/08; B08B 3/04; A23B 7/157; A23B 7/158; G05D 21/02; B26D 5/28; B26D 7/06

(52) U.S. Cl. CPC A23N 12/02; B08B 3/08; B08B 3/041; A23B 7/157; B26D 2210/02; G05D 21/02; B26D 5/28; B26D 7/0625; A23V 2002/00; A23B 7/158

(57) ABSTRACT

Methods and apparatus for a short-term wash treatment used in a food-processing system are provided. One example control system includes an interface configured to receive one or more first sensor signals from the food-processing system; and a processing system coupled to the interface and configured to determine, based on the one or more first sensor signals, to reduce an intensity of the short-term wash treatment; generate a first control signal to cause an increase in a pH of the short-term wash treatment in response to the determination; and control application of the short-term wash treatment with the increased pH to a product in the food-processing system. Further the system may include a human machine interface (HMI) configured to display information from the processing system to a user.

### CROSS-REFERENCE TO RELATED APPLICATIONS

The present Application for Patent claims benefit of and priority to U.S. Provisional Patent Application Ser. No. 62/794,184, filed Jan. 18, 2019, which is assigned to the assignee hereof and hereby expressly incorporated by reference herein.

### BACKGROUND

### Field of the Disclosure

The subject matter disclosed herein generally relates to food processing and, more particularly, to controlling and managing a short-term intense treatment for food processing.

### Description of Related Art

Water is used in many food processes. For example, water is often used to wash produce at different stages of processing. In many cases this water is recycled and used multiple times. This is particularly true of the wash processes including those used in the value added produce industry. It is important to ensure that this water does not add to the food safety hazards that might be associated with the food being processed. Accordingly, the water is controlled and monitored using a number of different methods and system to try and reduce any food safety concerns. The control requirements will vary with the food product being processed and the process.

Water chemistry management has been evolving with increased automation and improvements in instrumentation. There are still operations that use test strips and manual wet chemistry methods, but these are increasingly inadequate. To address these needs, more sophisticated controllers have come into play with more logic. Even with these developments, more efficient and reliable approaches are needed. It is also increasingly important to validate control.

Further, most Ready-To-Eat (RTE) produce is processed with two-stage washing. Repeating the same wash a third time generally yields no further benefits if the first two stages have been properly managed. For example, the primary wash system may remove dirt and debris. The primary wash system may also handle the bulk of the soluble organic load from any cutting or chopping operation. The secondary wash, whose water chemistry is generally easier to manage, is intended to complete the sanitation of the product. In recent years, the improved control of the water chemistry of both the primary and secondary wash systems has led to improvements in the sanitation of washed products and the control of cross contamination; however, more improvement is still needed to better mitigate microbial risk to consumers.

Much research has been done exploring the various compatible sanitizing agents for use in these two stage wash systems including chlorine, chlorine dioxide, ozone, and other active oxygen species. Other sanitizing agents have been considered such as fatty acids, organic acids, and silver ions but are not in use. None of these chemicals has provided a 4 log lethality to achieve a chemical pasteurization of the RTE product in a commercial setting. In fact, most processes fail to yield a consistent 2 log reduction. Some have asserted greater lethality in bench scale tests, but these greater lethality values do not carry over to commercial processing and often involve artificial conditions where a large number of organisms are applied and removed without time to become established on the product under test. Thus, currently no one is reporting a commercial pasteurization of an RTE produce product.

Engineering efforts have produced various flumes and tanks to provide agitation and mechanical action to enhance the sanitation process. For example, air jets and turbulence are designed into these systems. None of these designs has been so overwhelmingly successful that all previous equipment designs were superseded. In some cases, different designs are preferred for certain product types for product quality reasons. For these and other reasons, the RTE industry includes a wide variety of equipment.

Researchers have attempted to incorporate other sanitation strategies into process lines. The considered mechanisms of lethality include ultra-violet light, sonic energy, electric fields and electrical current and other exotic mechanisms. Here too, none of these approaches have entered into commercial practice. The search for additional lethality continues.

In spite of all this effort, pathogens remain at low levels on RTE produce as delivered to consumers. The hazard is generally small, but is not zero as there continue to be outbreaks and recalls. Some of these problems probably reflect poor application of existing art. Nevertheless, the RTE produce industry seeks more robust processes to ensure consumer safety. Such processes call for the industry to do something different.

Further, the complexity and control involved for modern food processes may exceed practical manual control. It may be impractical to manually monitor and control many aspects because of the rate at which change can occur. Additionally, it may be impractical to respond in a timely matter to make adjustments. Furthermore, assuming one could execute manual monitoring and control, it may most likely be important to record and process this data to validate that the process was in control. For an intense short-term treatment such control may be considered even more important. One or more cases disclosed herein address these considerations.

### SUMMARY

The systems, methods, apparatus, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved food safety.

Certain aspects provide a method for controlling a short-term wash treatment used in a food-processing system. The method generally includes determining, based on one or more first sensor signals, to reduce an intensity of the short-term wash treatment; increasing a pH of the short-term wash treatment in response to the determination; and controlling application of the short-term wash treatment with the increased pH to a product in the food-processing system.

Certain aspects provide a control system for controlling a short-term wash treatment used in a food-processing system. The control system generally includes an interface configured to receive one or more first sensor signals from the food-processing system; a processing system coupled to the interface configured to: determine, based on the one or more first sensor signals, to reduce an intensity of the short-term wash treatment; generate a first control signal to cause an increase in a pH of the short-term wash treatment in response to the determination; and control application of the short-term wash treatment with the increased pH to a product in the food-processing system. The system may further include a human machine interface (HMI) configured to display information from the processing system to a user.

Certain aspects provide a control system for controlling a short-term intense treatment used in a food-processing system. The control system generally includes at least one processor configured to execute computer-readable instructions. The computer-readable instructions include collecting, using a sensor disposed at the food-processing system, a sensor signal, generating one or more control signals for controlling one or more chemical pumps and one or more valves to provide the short-term intense treatment into the water of the food-processing system based on the sensor signal, and transmitting the one or more control signals to the one or more chemical pumps and one or more valves. The control system may further include a memory coupled to the at least one processor and configured to store one or more of the computer-readable instructions, the one or more control signals, and the sensor signal.

Certain aspects provide a non-transitory computer-readable medium for controlling a short-term wash treatment used in a food-processing system. The computer readable-medium includes program instructions that, when executed by a processing system, cause the processing system to perform operations including: determining, based on one or more first sensor signals, to reduce an intensity of the short-term wash treatment; increasing a pH of the short-term wash treatment in response to the determination; and controlling application of the short-term wash treatment with the increased pH to a product in the food-processing system.

Aspects generally include methods, apparatus, systems, computer-readable mediums, and processing systems, as substantially described herein with reference to and as illustrated by the accompanying drawings. Numerous other aspects are provided.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIGS. 1A through 1C are block diagrams showing a produce wash system, in accordance with certain aspects of the present disclosure.

FIGS. 2A and 2B are block diagrams showing a produce wash system, in accordance with certain aspects of the present disclosure.

FIG. 3 is a schematic of a produce wash system in a produce line, in accordance with certain aspects of the present disclosure.

FIG. 4 is a schematic of a produce wash system in a produce line, in accordance with certain aspects of the present disclosure.

FIG. 5 is a schematic of a produce wash system in a produce line, in accordance with certain aspects of the present disclosure.

FIG. 6 is a schematic of a produce wash system in a produce line, in accordance with certain aspects of the present disclosure.

FIG. 7 is a short-term wash device including a rotating drum for commercial wash control, in accordance with certain aspects of the present disclosure.

FIG. 8 is a short-term wash device including a slicer/dicer with spray nozzles, in accordance with certain aspects of the present disclosure.

FIG. 9 is a short-term wash device including an air column wash system for short-term wash treatment, in accordance with certain aspects of the present disclosure.

FIG. 10 is a timing belt in accordance with certain aspects of the present disclosure.

FIG. 11 is a flow chart showing a method of using a short-term wash treatment and/or short-term wash device in accordance with certain aspects of the present disclosure.

FIG. 12A is a block diagram of a short-term wash system that includes a rinse transition component in accordance with certain aspects of the present disclosure.

FIG. 12B is a schematic of a short-term wash system that includes a rinse transition component in accordance with certain aspects of the present disclosure.

FIG. 13 is a schematic of a short-term wash system that includes a rinse transition component in accordance with certain aspects of the present disclosure.

FIG. 14 is a flow chart showing a method of using a short-term wash treatment and/or short-term wash device in accordance with certain aspects of the present disclosure.

FIG. 15 is a block diagram of a control system for water used in produce processing that includes a water control system and produce wash equipment, in accordance with certain aspects of the present disclosure.

FIG. 16 is a block diagram of a control system for water used in produce processing with examples of sensor placement, in accordance with certain aspects of the present disclosure.

FIG. 17 is a block diagram of a control system for water used in produce processing showing examples of network integration, in accordance with certain aspects of the present disclosure.

FIG. 18 is a block diagram of a control system for water used in produce processing with examples of data storage memory locations, in accordance with certain aspects of the present disclosure.

FIG. 19 is a block diagram of a control system for water used in produce processing with distributed processing control, in accordance with certain aspects of the present disclosure.

FIG. 20 is a block diagram of a control system for water used in produce processing including pumps controlled by control signals, in accordance with certain aspects of the present disclosure.

FIG. 21 is a flow chart of a method for using a control system for water used in produce processing, in accordance with certain aspects of the present disclosure.

FIG. 22 is a flow chart of a method for using a control system for water used in produce processing, in accordance with certain aspects of the present disclosure.

FIG. 23 is a block diagram of a control system for controlling a short-term treatment, in accordance with certain aspects of the present disclosure.

FIG. 24 is a flow chart of operations for controlling a short-term wash treatment used in a food-processing system, in accordance with certain aspects of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience. It is contemplated that elements disclosed in one aspect may be beneficially utilized on other aspects without specific recitation.

### DETAILED DESCRIPTION

Aspects of the present disclosure provide apparatus, methods, processing systems, and computer-readable media for controlling water chemistry used for industrial food processing. For example, in one embodiment, a control system may be provided that moderates the pH of a pretreatment mixture and starts and stops mixture flow to match product flow. In another embodiment the control system includes interlocks to ensure that the short-term process time is not exceeded.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

As shown and described herein, various features of the disclosure will be presented. Various embodiments may have the same or similar features and thus the same or similar features may be labeled with the same reference numeral. Although similar reference numbers may be used in a generic sense, various embodiments will be described and various features may include changes, alterations, modifications, etc. as will be appreciated by those of skill in the art.

Embodiments described herein are directed to a system and method for controlling a wash solution in a wash system for produce handling. For example, according to one or more embodiments, a system and method include data collection using one or more sensors and generating control signals, based on the collected data, to control chemical pumps that adjust the amount of one or more chemicals in water used to wash produce that is being processed. The system can also include user input data as well has historical databases and analysis that can be used to generate the control signals. The control signals can also be generated based on the collected data, stored data, analysis, user input, a combination of data types, and/or other related data. Further, the control signals can also be generated for removing fouling from the sensors and related components based on the collected data, stored data, analysis, user input, a combination thereof, and/or other related data. Additionally, the control signals can further include scheduling the fouling removal based on the collected data, stored data, analysis, user input, a combination thereof, and/or other related data.

### Systems and Methods for a Short-Term Wash Treatment of Produce

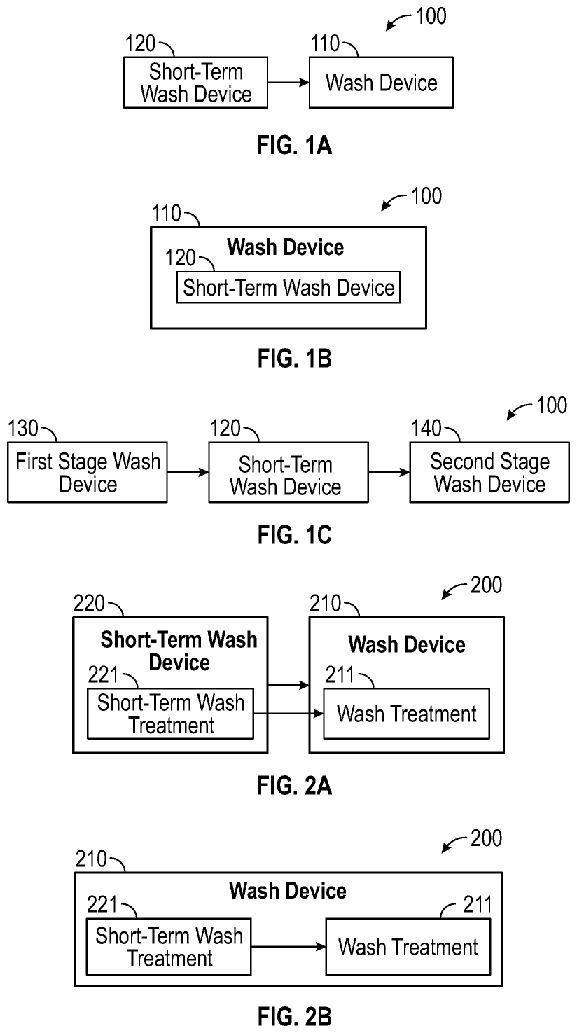

FIGS. 1A through 1C show block diagrams of a produce wash system 100 according to one or more cases. For example, FIG. 1A shows a produce wash system 100 that includes a wash device 110 and a short-term wash device 120 according to a case. The short-term wash device 120 is placed such that it is first in the process flow. Next is provided a wash device 110 that is provided after the short-term wash device 120 in the process flow such that the wash device 110 receives product/produce from the short-term wash device 120. Particularly, the short-term wash device 120 initially washes product and then provides the product to the wash device 110 which rinses the product and washes the product using a normal wash cycle.

FIG. 1B shows a produce wash system 100 that includes a wash device 110 and a short-term wash device 120. In this embodiment, the short-term wash device 120 is provided at some point within the wash device 110. Accordingly, product that is provided to the wash device 110 will first be washed by the short-term wash device 120 and then provided to the wash device 110 for rinsing and a normal wash cycle.

FIG. 1C shows a produce wash system 100 that includes a short-term wash device 120 as well as a first stage wash device 130 and a second stage wash device 140. The first stage wash device 130 is provided before both the short-term wash device 120 and the second stage wash device 140. Accordingly, the first stage wash device 130 does a preliminary normal wash cycle. The short-term wash device 120 is provided next such that it receives the product from the first stage wash device 130. The short-term wash device 120 then washes the product using a short-term wash treatment and sends the product on to the second stage wash device 140. The second stage wash device 140 receives the product and proceeds to rinse and wash the product using a normal wash cycle similar to the first stage wash device 130. By providing the first stage wash device 130 first, the produce wash system allows the wash cycle of the first stage wash device to deal with the initial produce load so that a short-term wash cycle of the short-term wash device can be better controlled and applied consistently to the produce.

According to another case, similar benefits can be derived from a pre-rinse wherein the rinse removes the initial organic load and debris such as soil. This pre-rinse allows the short-term treatment to be more effective and potential reduces total water usage. The pre-rinse is done prior to the short-term wash treatment. This pre-rinse is positioned so as to prevent soil and debris from interfering with the short-term wash treatment or from being carried over into the wash system. It can be advantages to make this pre-rinse the last use of wash water prior to disposal.

FIGS. 2A and 2B are block diagrams showing a produce wash system 200 and the specific treatments that are used to wash product/produce according to one or more cases. For example, FIG. 2A shows a produce wash system 200 that includes a short-term wash device 220 and a wash device 210. The short-term wash device 220 receives and washes the product using a short-term wash treatment 221. The product is then provided to the wash device 210. The wash device 210 takes the produce that has been washed using the short-term wash treatment 221 and rinses and washes the product using a wash treatment 211. According to another case as shown in FIG. 2B, a produce wash system 200 includes a wash device 210 that is provided with both the short-term wash treatment 221 and the wash treatment 211. The wash device 210 first applies the short-term wash treatment 221 to received product. Then, after a set pretreatment time period, the wash device 210 switches to the wash treatment 211. The wash treatment 211 is then applied to the product thereby rinsing the product of the short-term wash treatment 221 and further washes the product using the wash treatment 211.

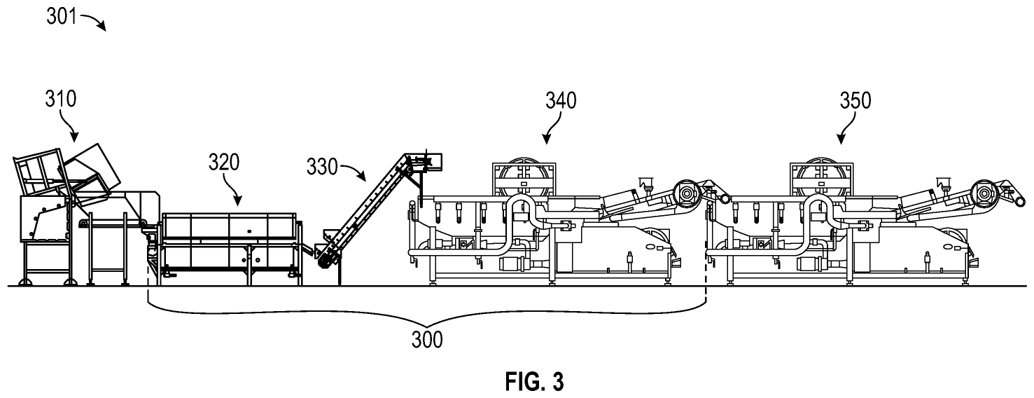

FIG. 3 is a schematic of a produce wash system 300 in a produce line 301 according to a case. The produce line 301 includes a trim belt 310, a rotating drum short-term wash device 320, a timing belt 330, a first wash stage device 340, and a second wash stage device 350. The produce wash system 300 includes the subset of items including the rotating drum short-term wash device 320, the timing belt 330, and the first wash stage device 340. In another embodiment, the timing belt 330 may be excluded by elevating the rotating drum short-term wash device 320 in relation to the first wash stage device 340. This can be accomplished by elevating the rotating drum short-term wash device 320 using a platform or an elevated floor or by setting the first wash stage device 340 on a lower surface compared to the rotating drum short-term wash device 320 such that the rotating drum short-term wash device 320 can directly provide the product to the first wash stage device 340. The overall produce line 301 first includes the trim belt 310 which is configured to initially receive the product/produce for processing. The trim belt 310 provides the product to the rotating drum short-term wash stage 320 that applied a short-term wash treatment to the product. The short-term wash treatment is left on the product for a short prewash treatment time period which can be adjusted using the timing belt 330 onto which the product is provided once out of the rotating drum short-term wash device 320. The product then travels along the timing belt 330 and then is deposited into the first wash stage device 340 which applied a wash treatment to the product. The wash treatment rinses off the short-term wash treatment and further provides additional slower less abrasive/damaging washing of the product. From there the product then continues along the produce line 301 entering into the second wash stage device 350 for another round of washing using a wash treatment. Once this wash step is complete the product is ready to move along the produce line 301 to be further processed and packaged by other device (not shown).

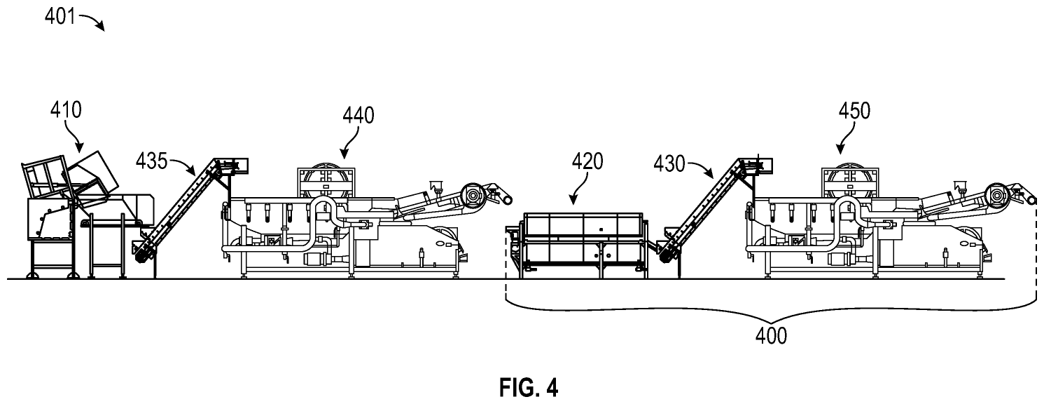

According to another case, FIG. 4 shows a schematic of a produce wash system 400 in a produce line 401 placed at a different location along the produce line 401 along with some different devices. Specifically, in this embodiment the produce line 401 includes a trim belt 410, a first timing belt 435, a first wash stage device 440, a rotating drum short-term wash device 420, a second timing belt 430, and a second wash stage device 450 provided in the order. Thus, the product is initially provided to the trim belt 410, which after processing sets the product onto the first timing belt 435. The first timing belt 435 transfers the product into the first wash stage device 440. The first wash stage device 440 does a first wash of the product using a wash treatment. The first wash stage device 440 then deposits the product into the rotating drum short-term wash device 420. The rotating drum short-term wash device 420 applies a short-term wash treatment to the product and then sends the product along the produce line 401 toward the next wash cycle. Specifically, the product is provided onto the second timing belt 430 which rotates and moves the product at such a pace that the short-term wash treatment is left on the product for a set prewash time period before it is finally received at the second wash stage device 450 which rinses the short-term wash treatment off the product using the wash treatment found within the second wash stage device 450 which also further provides additional cleaning properties.

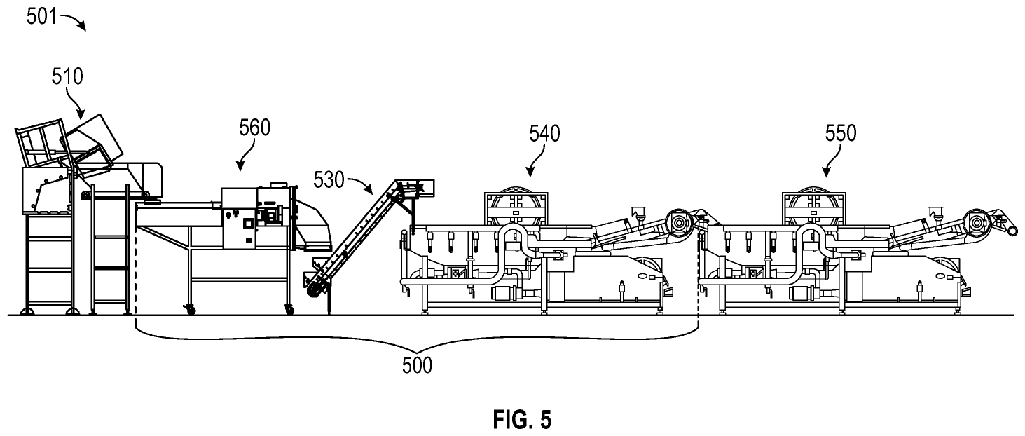

According to a case, FIG. 5 shows a schematic of a produce wash system 500 in a produce line 501 that uses a different type of short-term wash device for applying the short-term wash treatment. Specifically, the produce wash system 500 includes a slicer/dicer short-term wash device 560, a timing belt 530, and a first wash stage device 540. In addition to the produce wash system 500, which includes the slicer/dicer short-term wash device 560, the timing belt 530, and the first wash stage device 540, the produce line 501 further includes a trim belt 510 that initially feeds the product to the produce wash system 500 and a second wash stage 550 that takes the product from the produce wash system 500 and runs a second wash cycle using wash treatment.

It is instructive to consider a specific embodiment. For example, to prepare chopped Romaine lettuce with a two tank flotation line using a silver dihydrogen citrate short-term wash treatment, a system such as illustrated in FIG. 5 can be used. In this system, product such as head lettuce is fed into the slicer/dicer short-term wash device 560 when it is treated with the silver solution. The slicer/dicer short-term wash device 560 affords efficient distribution of the treatment solution. This solution needs to be substantially chloride free or the silver ions are rendered inactive as a cloudy precipitate. It can generally be recycled with makeup for the solutions carried forward with the product on the timing belt 530. The speed of the timing belt 530 is adjusted according to the time involved for treating the particular product, which is generally between 30 and 60 seconds. Longer treatments are less practical given the product throughput and the potential for treatment solutions to shorten the shelf-life. The impact of the silver solution is quenched by delivery of the product into the first wash stage device 540. Makeup water enters the first wash stage device 540 as a final rinse after the second wash stage 550. Water from the second wash stage 550 is used as makeup water for the first wash stage device 540. One skilled in the art will recognize that many different wash systems could be coupled to this short-term wash treatment system.

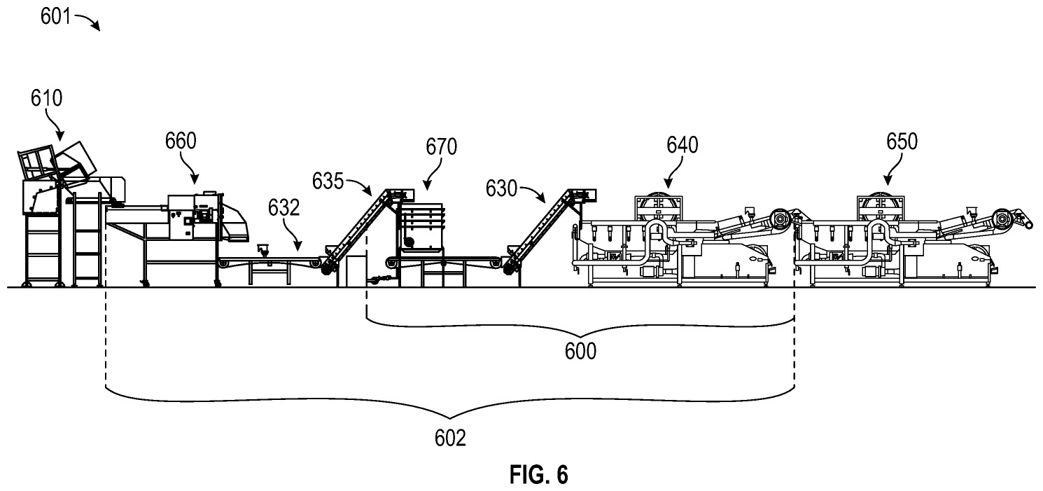

According to one or more cases one or more short-term wash devices may be included in the produce line 601, one or both of which may be used to apply the same or different short-term wash treatments. For example, FIG. 6 shows a schematic of a first produce wash system 600 in a produce line 601 according to a case. The first produce wash system 600 includes an air column short-term wash device 670, a second timing belt 630, and a first wash stage device 640. The air column short-term wash device 670 may be a fluidized bed according to an embodiment. In addition to the first produce wash system 600, the produce line 601 further includes a trim belt 610, a slicer/dicer 660 with rinse, a transfer belt 632, a first timing belt 635, and a second wash stage device 650. Thus, product/produce is initially provided at the trim belt 610 which deposits the produce into the slicer/dicer that processes the produce and deposits it on the transfer belt 632 that places the produce onto the first timing belt 635 where the produce is taken and placed into the air column short-term wash device 670. The air column short-term wash device 670 applies a short-term wash treatment to the produce and then transfers the produce to the second timing belt 630 which takes the produce and deposits the produce into the first wash stage device 640 that contains a wash treatment. The wash treatment is thereby applied to the produce rinsing off the short-term wash treatment and further washing the produce. The produce is then provided into the second wash stage device 650 where the produce undergoes another round of wash treatment application.

Further, in another embodiment, FIG. 6 also shows a second produce wash system 602 that includes both a first and second short-term wash devices. Specifically, the slicer/dicer 660 can also apply a short-term wash treatment while processing the produce and can therefore operate as a slicer/dicer style short-term wash device 660. This short-term wash device 660 may apply a short-term wash treatment that can, for example, control properties for controlling lachrymator release from the produce. The produce is then transferred using the transfer belt 632 to the first timing belt 635 and into the air column short-term wash device 670 that applies a second short-term wash treatment that can totally or partially rinse the initially applied short-term wash treatment. The second short-term wash treatment may provide antimicrobial properties and/or potentiating properties for subsequent wash treatments. From the air column short-term wash device 670 the produce is then transferred to the second timing belt 630 that takes the produce which then continues on through the first wash stage device 640 and the second wash stage device 650.

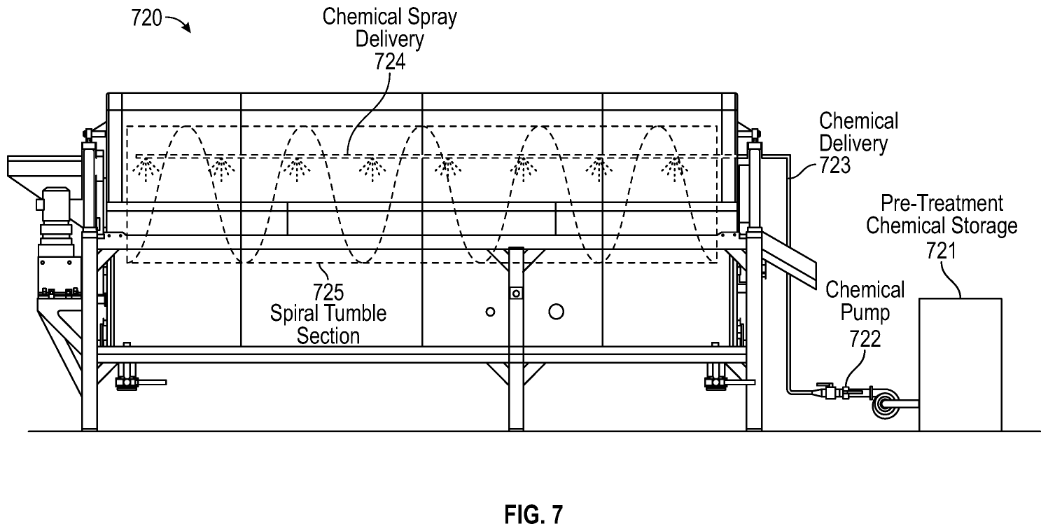

According to one or more embodiments, FIG. 7 shows a rotating drum short-term wash device 720 similar to the rotating drum short-term wash devices 320 and 420 shown in FIG. 3 and FIG. 4, respectively. According to one embodiment, the rotating drum short-term wash device 720 includes at least a rotating drum 725, which may also be called a spiral tumble section, for commercial wash control. The rotating drum short-term wash device 720 includes short-term wash treatment chemical storage container 721, a chemical pump 722, and a chemical delivery system 723 that includes chemical spray delivery devices 724, which may also be called a spray curtain, spray nozzles, or simply a spray device. Thus, as produce is provided into the spiral tumble section, the chemical pump 722 pumps the short-term wash treatment from the short-term wash treatment chemical storage container 721 into the chemical delivery system 723. The short-term wash treatment travels through the chemical delivery system 723 until it reaches the chemical spray delivery devices 724 that are disposed such that their spray stream falls into the spiral tumble section onto the produce tumbling therein. Thus the produce is sprayed with the short-term wash treatment as the produce tumbles and travels through the rotating drum 725. The produce is then rotated along the spiral tumble section and out of the rotating drum short-term wash device 720 toward a wash stage device that rinses off the short-term wash treatment using a wash treatment.

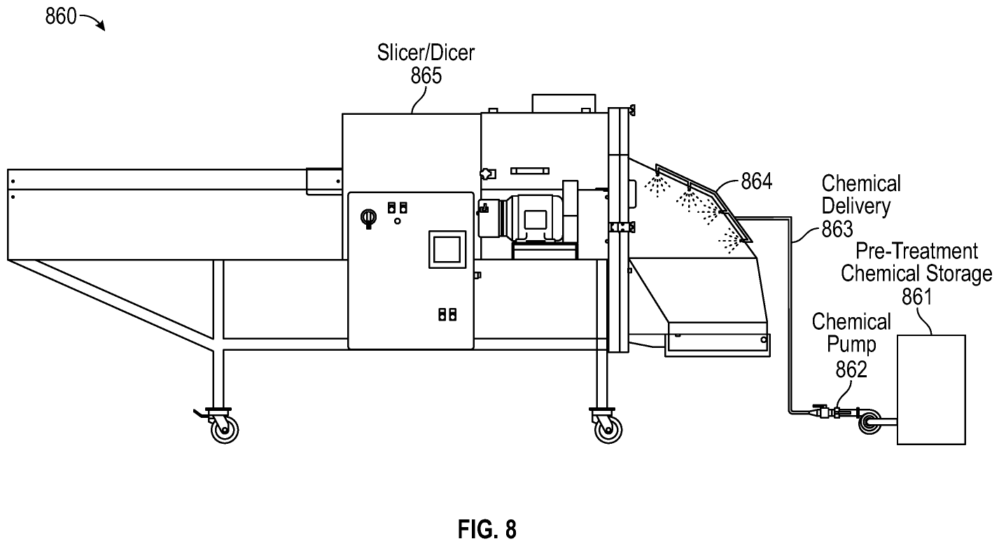

According to one or more embodiments, FIG. 8 shows a short-term wash device 860 including a slicer/dicer 865 with a spray delivery device 864, which may also be called spray nozzles, a spray curtain, or simply a spray device. The short-term wash device 860 is similar to the slicer/dicer type short-term wash devices 560 and 660 from FIG. 5 and FIG. 6, respectively. The short-term wash device 860 also includes a short-term wash treatment chemical storage container 861 and a chemical pump 862 that provides the short-term wash treatment to a chemical delivery system 863 that includes the spray nozzles. The short-term wash treatment chemical storage container 861 is configured to store the short-term wash solution. Thus, the short-term wash treatment is pumped from the short-term wash treatment chemical storage container 861 using the chemical pump 862 through the chemical delivery system 863 and out the spray nozzles as shown. According to other embodiments, the spray nozzles may be placed within the slicer/dicer 865, before the slicer dicer 865, after the slicer/dicer 865 as shown, or a combination thereof.

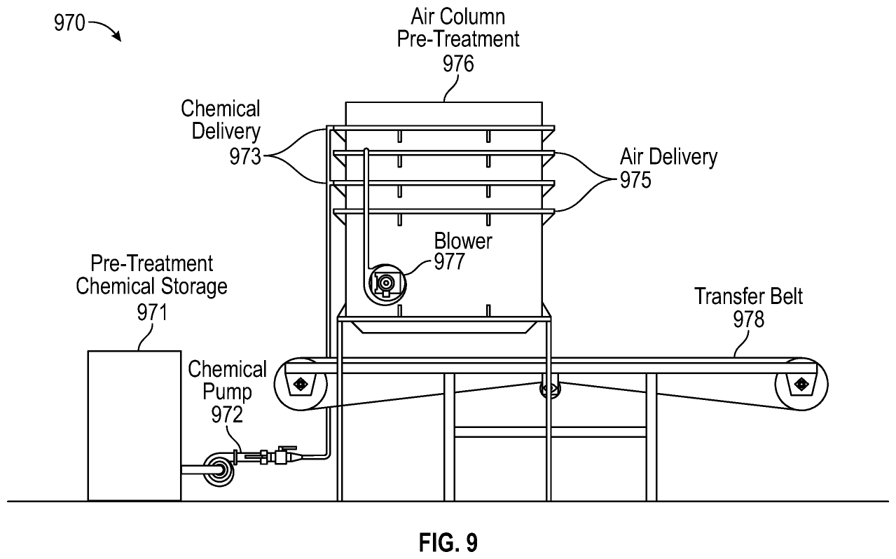

FIG. 9 shows an air column short-term wash device 970 that includes an air column system 976 for short-term wash treatment application to produce according to a case. The air column short-term wash device 970 is similar to the air column short-term wash device 670 as shown in FIG. 6. The air column short-term wash device 970 includes the air column system 976 that includes a blower 977 and an air delivery system 975 that delivers the air provided by the blower 977 into the air column system 976. The air column short-term wash device 970 also includes a short-term wash treatment chemical container 971, a chemical pump 972, and a chemical delivery system 973. The chemical pump 972 pumps the short-term wash treatment out from the short-term wash treatment chemical container where it is being stored and pumps it into the chemical delivery system 973. The chemical delivery system 973 provides the short-term wash treatment using nozzles placed near the air delivery system 975 such that the short-term wash treatment is provided into the air column system 976. Accordingly, the produce that is provided into the air column system 976 is coated with the short-term wash treatment and then provided onto a transfer belt 978 that transfers the produce to the next device in the produce line where the short-term wash treatment is either left on the produce for a prewash time period and/or rinsed off using a wash treatment.

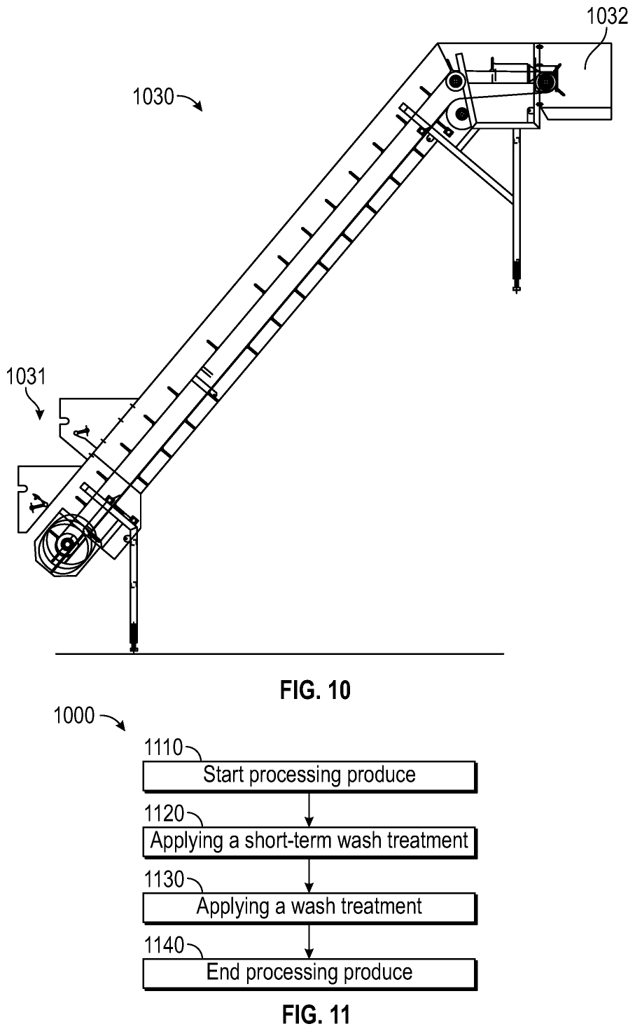

FIG. 10 is a timing belt 1030 in accordance with certain aspects of the present disclosure. The timing belt 1030 is substantially similar to the timing belts 330, 430, 435, 530, 630, and 635 as shown in FIGS. 3-6. The produce is provided at a first end 1031 of the timing belt 1030. The produce then travels up the timing belt 1030 and the timing belt rotates clockwise lifting the produce toward a second end 1032 that ends and drops the produce into the next device in a produce line. The timing belt 1030 can be set to rotate at different speeds in order to adjust the amount of time the short-term wash solution is on the produce to the desired length of time that the short-term wash treatment should be on the produce. As shown in FIGS. 7 through 10, the short-term wash device can take the form of a number of different devices but is not limited thereto. Particularly, the short-term wash device can be any number of other devices used in a produce line and can even be embodied as a device that's only function is to apply the short-term wash treatment. Accordingly, in one or more embodiments, the short-term wash device may be any device that is placed before another wash cycle that is configured to apply a short-term wash treatment to the product for a particular time before providing the treated product to the next wash cycle that rinses the short-term wash treatment from the product.

FIG. 11 is a flow chart showing a method 1000 of using a short-term wash treatment and/or short-term wash device according to one or more cases. Initially, processing a product/produce begins by providing the produce into a trim belt that then deposits the produce into a produce wash device that includes a short-term wash device followed by a wash device (operation 1110). Then a short-term wash treatment is applied using the short-term wash device to the product such that the short-term wash treatment remains on the product for a pretreatment time that lasts until the product reaches the wash device (operation 1120). A wash treatment is then applied using the wash device to the product such that the wash treatment rinses the short-term wash treatment from the product defining the end of the pretreatment time (operation 1130). The pretreatment time is set at or below a damage threshold time beyond which the short-term wash treatment damages the product beyond a damage threshold. The damage can be defined as, for example, the point at which the produce discolors, wilts, changes taste, or other properties shift such that it can no longer be sold to a consumer. Finally, the product treatment process is either completed or may continue on through another round of washing in a second wash device or onto other processing and packaging steps (operation 1140).

A short-term wash, which may also be called an intense prewash treatment or prewash treatment, using a short-term wash treatment and device as well as a wash treatment and device synergistically enhances the lethality of traditional wash systems for ready-to-eat (RTE) produce. A short-term wash treatment and short-term wash device, which may also be called a prewash system, permits the usage of materials that would otherwise potentially damage or otherwise prevent the sale of RTE produce. For example, a prewash with a phosphoric acid and propylene glycol solution or with a silver dihydrogen citrate solution has proved particularly effective when exposure times are controlled and limited. Such short-term wash systems are compatible with high levels of water recycling to manage total water use.

According to one or more embodiments, the quenching of the short-term treatment solution could overwhelm the water management of the primary flume wash system. As illustrated in drawing 12A, under these conditions, it may be desirable to have a rinse transition component 1222 placed after the application of the short-term treatment solution by a short-term wash device 1220 and before a wash device 1210. Specifically, as shown, a produce wash system 1200 includes a wash device 1210 and a short-term wash device 1220 with a rinse transition component 1222 there between. According to some embodiments, the rinse transition component 1222 may include a multistage stage transition and an independent water source from the main wash device 1210.

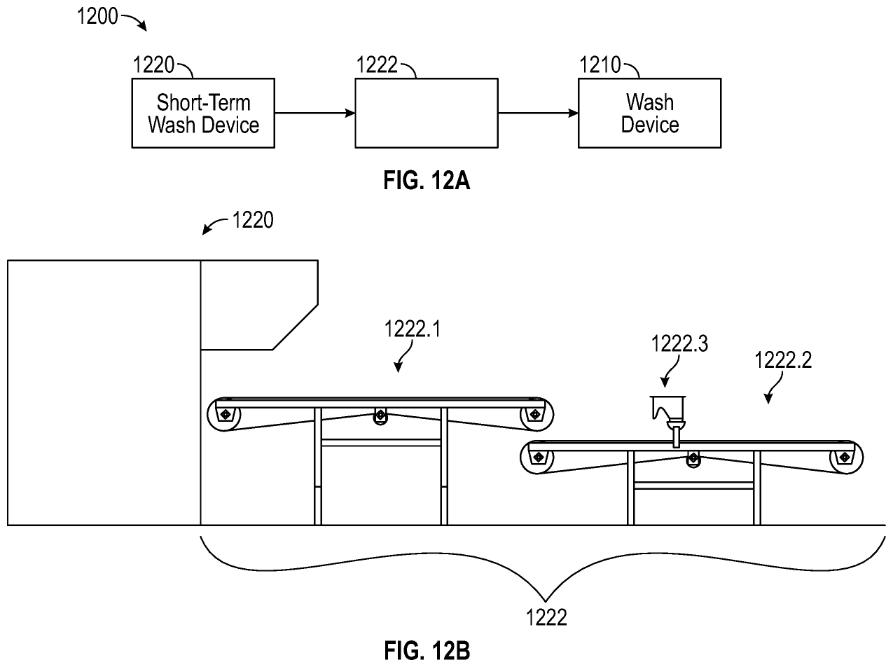

For example as shown in FIG. 12B, according to one or more embodiments, a two-stage (1222.1 and 1222.2) rinse transition component 1222 can be implemented to partially and/or completely quench the short-term treatment solution by applying a rinse solution prior to transitioning the product to a primary flume wash system as the main wash device 1210, as shown in FIG. 12A. The rinse solution may be water from the short-term wash device or the wash device. The rinse solution may also be some other liquid wash solution that neutralizes and/or quenches the short-term wash treatment.

According to another embodiment, each stage (1222.1 and 1222.2) could be further subdivided if necessary to affect the desired transition. For example, according to one or more embodiments, in the first stage 1222.1, the objective may be to remove as much of the short-term treatment solution as possible. This solution can be recycled in some cases such as when used with the previously described phosphoric acid system. In others, such as the silver ion system, recycling is not practical so that application levels may most likely be minimized to be cost effective. The second zone 1222.2 can use water from the primary flume to further wash the product before in it enters the primary flume. This water is applied using, for example, a water spray 1222.3. The water used in this stage would otherwise just have gone to the drain as make up water is added to the primary flume. Accordingly, additional use can be made of water from the primary flume prior to discarding. Further, according to one or more embodiments, another benefit of this two zone or multi zone system is to avoid overloading the primary flume with treatment chemicals.

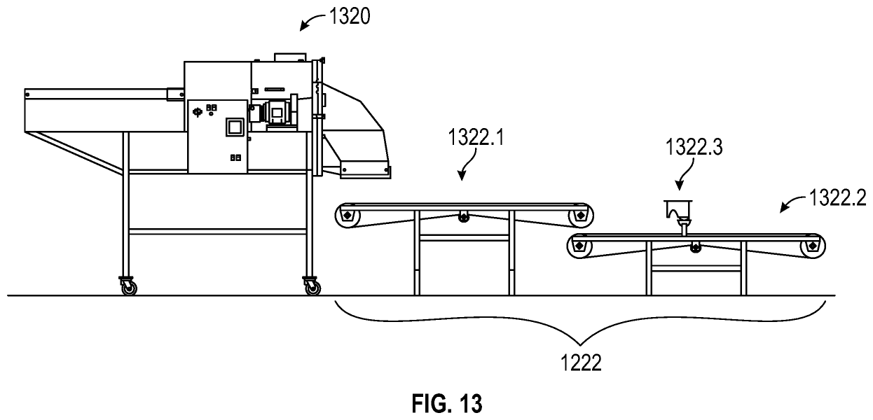

FIG. 13 depicts a rinse transition component 1322 that is placed in a produce wash system after a short-term wash device 1320. The short-term wash device can be a slicer/dicer device as shown in FIG. 13. According to other embodiments, the short-term wash device 1320 can be other devices as discussed above. Further, the short-term wash device is not limited thereto as it could take the form of another device that is able to apply the short-term treatment to product and depositing it on the rinse transition component 1322. The rinse transition component 1322 includes a multistage rinse system. Specifically, the rinse transition component includes a first stage 1322.1 and a second stage 1322.2. The first stage 1322.1 and the second stage 1322.2 each include a conveyer belt, which can also be called a drain scroll, and a liquid application device to rinse the short-term treatment from the product. For example, the second stage 1322.2 conveyer belt includes a spray device 1322.3 that sprays the product with water from the main wash as the product moves along the belt toward the main wash device. Further according to one or more embodiments, the first stage 1322.1 and the second stage 1322.2 can instead be any of the other discussed devices through which product can move and a rinse applied. For example, according to an embodiment, a timing belt could be used.

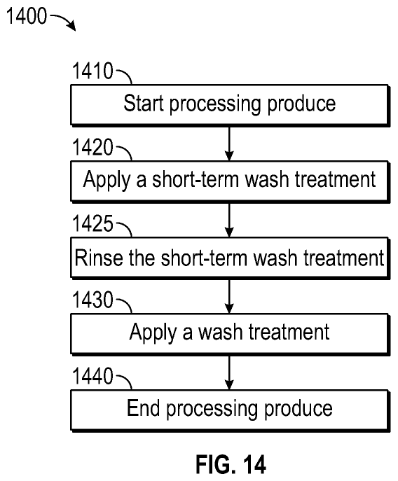

FIG. 14 is a flow chart showing a method 1400 of using a short-term wash treatment and/or short-term wash device along with a rinse transition component according to one or more cases. Initially, processing a product/produce begins by providing the produce into a trim belt that then deposits the produce into a produce wash device that includes a short-term wash device followed by a wash device (operation 1410). Then a short-term wash treatment is applied using the short-term wash device to the product such that the short-term wash treatment remains on the product for a pretreatment time that lasts until the product reaches either the rinse transition component or the wash device (operation 1420).

Next, the rinse transition component rinses the product (operation 1425). This rinsing can be done in a multistage arrangement were the product is rinsed more than once using water from different sources. For example the rinse transition component can include a first drain scroll that rinses the product using water from an independent source or from the short-term wash device and a second drain scroll that uses water from the main wash.

Further, a wash treatment is then applied using the wash device to the product such that the wash treatment rinses any remaining short-term wash treatment from the product defining the end of the pretreatment time if it was not already ended during the rinse transition component rinsing (operation 1430). The pretreatment time is set at or below a damage threshold time beyond which the short-term wash treatment damages the product beyond a damage threshold. The damage can be defined as, for example, the point at which the produce discolors, wilts, changes taste, or other properties shift such that it can no longer be sold to a consumer. Finally, the product treatment process is either completed or may continue on through another round of washing in a second wash device or onto other processing and packaging steps (operation 1440).

The above noted need for more robust processes for RTE produce provided a starting point for providing short-term wash treatments while managing overall water usage. In one more embodiments, four considerations for implementing this additional process strategy can be taken into account without compromising water management. First, one determines the best location for treatment. Second, one determines how that treatment will be carried out. Third, one determines the formulation of the treatment. And finally, one determines how this short-term wash treatment fits into the water reuse needs of the specific produce line. These considerations are combinatorial yielding many specific embodiments as discussed herein.

With regards to location, the range of possibilities is limited but not without choices. Given the nature of the intense treatments and their short durations, for example less than 1 minute, the treatment should be somewhat proximal to the primary wash stage such as the rotating drum short-term wash device 320 stage as illustrated in FIGS. 3 and 4. However, according to another embodiment, the treatment can be included in a cutting or chopping operation as illustrated in FIGS. 5 and 6. These intense short-term wash treatments are generally inappropriate for field application where the time of exposure would be highly variable and on the order of hours and perhaps days if the raw material is shipped to a regional processing facility. However, it should be noted that the short-term wash treatment application can be moved to an intermediate position between the primary and secondary stages as illustrated in FIG. 4 and still achieve the same type of benefits. This embodiment is particularly helpful where the short-term wash treatment was inhibited by materials removed in the primary wash by the first wash stage device 440.

With regards to how the treatment is applied, there are several operating parameters that are important to consider and also multiple types of equipment that can be considered as ways to control these parameters. Feed rate, dispersion, uniformity of coverage, and treatment time are operating parameters to consider. These are all interrelated and will depend on the equipment used for the treatment. For example, according to an embodiment, about 1 liter per minute is sufficient to wet the surface of all leaves when nozzles are place in a slicer/dicer short-term wash device 865, which may also be called a pilot plant shredder or a chopper/shredder short-term wash device as shown in FIG. 8 when the product feed rate is about 1 pound per minute. When the treatment is effected in the well-mixed environment of such a slicer/dicer 865, the distribution and uniformity are almost ensured. This is not always the case for a setup that uses a timing belt 1030 as shown in FIG. 10 where feed rates may most likely be controlled and limited to reduce product overlap in the active zone by using the timing belt 1030 between short-term wash and normal wash cycles. This setup allows easy adjustments and experimental treatments to explore the benefits of different short-term wash treatments, but a more active process can be provided using other devices as shown in other disclosed embodiments. For example, FIG. 7 illustrates a commercial approach using a rotating drum short-term wash device 720 that includes a rotating drum 725, that can also be called a rotating auger, that includes a chemical delivery system 723, that can also be called a central spray system, to achieve the desired dispersion and uniformity of coverage of the short-term wash treatment. Thus, one or more embodiments provide approaches to ensure that the treatment solution contacts all parts of the product surface, and that contact time is limited to avoid quality loss.

According to one or more embodiments, a system and method of wetting product surfaces using pretreatment and other elements is provided. According to one or more embodiments, an addition of surfactants can be provided and can provide advantageous features and outcomes. Further, in accordance with one or more embodiments, a small nozzle opening can be used along with a high pressure nozzle to yield very small droplet size. These small droplets can improve surfaces wetting. For example, in one or more embodiments, the very small droplets are approximately 5 micrometers to approximately 20 micrometers. In another embodiment, the droplets are approximately 2 to approximately 40 micrometers. In one or more embodiments, the mechanism of action for the small droplets is believed to be diffusion which is enabled by the removal of the steric hindrances associated with the naturally occurring protective niches on the product surfaces. In other words, and in accordance with one or more embodiments, the small droplets go where big droplets could not due to physical or chemical barriers. The appropriate size for various products and pretreatment solutions can reasonable by expected to vary on a case by case basis. For example, in accordance with one embodiment, about 15 micrometers droplet size can be used to start optimization.

Furthermore, one or more embodiments using this surface wetting can overcome the limitations caused by surface tension which would normally provide safe havens for bacteria sheltering in the protective niches. Without surface wetting, the wash solution flows over the surface of the protective niches on the product surface. Once the surface is wet, it appears that normal wash action is more effective. According to one or more embodiments, this relates to diffusion in the liquid wetting the surface as opposed to migration from solution to the air space in the niche. Expressed more simply, after spraying the surface with the very small droplets, the wash solutions are better able to reach and therefore inactivate the bacteria of interest.

The use of small droplets such as described herein affords another benefit. The resulting mist provides better coverage with less spray material. This affords a cost savings and less material for disposal if the spray solution is used once in a single pass treatment system. For example, in accordance with one or more embodiments, silver ion solutions often need to be used as single pass.

With regards to formulation of the short-term wash treatment, a distinction is differential sensitivity to the intense solution components. It has been observed that the more intense short-term wash treatments have more impact on the bacteria/microbes of interest than on the produce allowing shorter treatment times with greater lethality and less quality loss. For each product, one can balance the lethality of the concentration and time of the process against the damage to the product and the related loss in shelf life. This is similar to the situation with thermal processing. Ultra-high-temperature (UHT) processing utilizes extremely high temperatures to process milk but for very short times. This extreme yields the best quality sterile milk. In contrast, fresh pasteurized eggs are processed for long times at moderate temperatures to avoid denaturing or cooking the eggs because the eggs are more sensitive to temperature than the bacteria. Using the short-term wash treatment allows for the process of produce processing to be more like milk in that we can use intense chemical treatments with short durations. In the extreme as with UHT milk, the minimum durations will only be limited by the ability to handle the RTE product without physical damage. The concentration and treatment times for any of these short-term wash treatments can be adjusted based on the product to be treated.

In accordance with one or more cases, it is possible, but not required, that any residues from the short-term wash treatment be removed from the product by the conventional wash treatment and wash device/system. If there are no residues and no residual activity, the treatment is to be considered a processing aid and does not require inclusion on the ingredient statement. When this is the case, the conventional wash system can be viewed as quenching the short-term wash treatment.

There are many short-term wash treatments that can meet the different sensitivity and residue removal specifications. This number can be increased by including inert or at least non-interfering ingredients at various concentrations. As an example, a combined solution of about 6% phosphoric acid and about 2.5% propylene glycol is useful. This solution provides greatly enhanced lethality at the end of the conventional wash with treatment durations of 10 to 60 seconds. According to other cases, with different product handling equipment, higher concentrations and shorter durations are obvious extensions. In a traditional wash system adjuvants are generally present at levels less than a few hundred ppm which represent a lower bound where the short-term wash treatment becomes just another wash stage and would not be expected to add useful additional lethality.

It is possible that this intense short-term wash treatment renders the bacterial microbes more susceptible to inactivation by the chlorine in the wash system. The phosphoric acid and propylene glycol residual are lost in the wash system where they act in concert with the other constituents of the wash system. Similar behavior is observed with other acids and simple polyols. Treatments with this family of materials are generally limited to less than a minute with an optimum around 30 seconds to avoid quality loss. Short-term wash treatment solutions without the polyol and just the acid, particularly citric, lactic, or acetic acids, are beneficial, but such solutions are often less effective than the comparable solution with the polyol. As part of managing the overall water usage of the wash system, the short-term wash treatment can be formulated with water from the primary wash system. There are other water management opportunities discussed in the cases provided herein.

As another formulation example, 10-50 ppm silver dihydrogen citrate in 3-5% citric acid can be provided in the short-term wash treatment. This combination adds a new mechanism of lethality which acts synergistically with the conventional wash system. For example, the chlorine in a conventional wash system will produce chloride which will inactivate the silver and facilitate removal during the wash leaving minimal residues. This short-term wash treatment solution is made with essentially chloride-free water—otherwise the silver ions are sequestered by any present chloride.

Another formulation example of the short-term wash treatment is a hybrid between the two mentioned above. Particularly, silver dihydrogen citrate can be diluted in a lactic acid glycerin solution maintaining the neutral charge for the silver complex and gaining the complementary benefits of the acid polyol system.

Further, water use and reuse are increasingly important in RTE produce wash systems. This complexity devolves from the cost of water, the cost of discharging water, the cost of water treatment chemicals, and the cost of chilling the water. A short-term wash treatment that does not intrinsically include water reuse will be less desirable than a process that includes water reuse. Additionally, a process where the short-term wash treatment can be used for multiple passes will be inherently more interesting than one which does not allow reuse provided the pretreatment does not lose effectiveness. With these constraints in mind, one approach to this water management challenge is to filter and reuse the wash treatment solution. There will be some losses to the conventional wash system, but these losses will partially avoid the addition of make-up water to the conventional wash system. Alternatively, the short-term wash treatment can be used once prior to being used with dilution in the primary wash treatment and system. Some of the numerous approaches are specifically examined in the specific embodiments discussed herein.

Another embodiment can be superior for a mechanically sensitive product that does need to be chopped or cut. For example, baby leaf product including spinach can be treated with an air column spray system, which can also be called an air column short-term wash device 970, as illustrated in FIG. 9. The leaves are dropped into an air column system 976 surrounded by a chemical delivery system spray devices 973. The air column system 976 has reverse air flow to ensure that leaves receive a coating of the short-term treatment solution prior to being deposited on a treatment transfer belt (30 seconds) before entering a two-tank flotation system. In accordance with one or more embodiments other short-term wash treatments could be substituted depending on the produce. In this embodiment, the transfer belt 978 serves as a drain scroll and timing belt to allow recycling the short-term wash treatment solution such as a phosphoric acid (4%) and propylene glycol (2%) solution. The carryover on product from this retreatment contributes to the pH control of the primary wash tank reducing the need for other chemicals. There are many factors that affect the total lethality of this system such as product overload, inadequate chlorine in the flotation tanks, or incomplete pH control. When these basic operating parameters are controlled, substantial increases in lethality are achieved over similar wash systems.

The embodiment shown in FIG. 6 incorporates an additional water management feature along with the short-term wash treatment. As shown, product is dumped into a slicer/dicer 660 before being rinsed. Product could be rinsed by other means if cutting was not needed as for baby greens. This rinsing step removes soil, and if product is cut, cell and tissue debris so the soil (and debris) do not enter the balance of the wash system. The small amount of water used for this rinse step can be processed to allow reuse by centrifugation, filtration or other well-known techniques. In some cases it may simply be better to make this single use water, particularly if this water has already been used in later operations making it part of a more extreme counter flow usage of water. This rinse step delivers field debris free product that is substantially free from tissue debris from cutting to the prewash treatment. This two stage pretreatment can greatly enhance the useful life of the short-term wash treatment solutions in the wash system and the recycled short-term wash treatment. The water from this rinse step can be derived from the primary wash system as it need not be new water.

According to a case, spinach that is inoculated to 104 cfu/g with a mixed culture of generic E. coli can be washed using the short-term wash treatment. For example, this spinach can be sliced and treated with various short-term wash treatments prior to washing through a commercial two stage Jacuzzi wash system at pH 5 at 15 ppm free chlorine. Treatments included city water as a control, SW™ and SWO™ (SmartWash Solutions LLC, Salinas, Calif.) and 50% Citric acid. It should be noted that although the citric acid solution was most effective, it turned the product unacceptably yellow when a 30-second treatment time is used in such a case. After short-term wash treatment, samples collected and examined for residual E. coli may provide the following comparative total log reductions are reported in Table 1:

TABLE 1

| Prewash Treatment | Log Reduction in E. coli |
|---|---|
| City Water | 1 |
| 1:2 dilution SW:City Water | 2.5 |
| 1:2 dilution of SWO:City Water | 2.5 |
| 50% Citric acid | 3 |

Further, according to another embodiment a short-term wash treatment can work with a produce wash system in the control of lachrymator release from cut, chopped or sliced onions. Specifically, the coordination between the wash system and the short-term wash treatment is one of contrast. A solution of 0.05 to 0.25% bisulfite in dilute acid with a diol or other small polyol is applied to onions during the cutting process. Normally, this would prompt labeling requirements on the finished product. However, in this case, the bisulfite reacts completely with the oxidizer in the wash system removing the sulfite residue. This treatment protected sensitive individuals from the lachrymators of the onions during a chopping operation. Also, sulfite levels were considerably less than the raw onions which are noted to be a high sulfite food.

In reducing this embodiment to practice, it has been found that 20 g of sodium bisulfite and 500 mls of either SmartWash Solution SW, SWO, or SWPro (SmartWash Solutions LLC, Salinas, Calif.), all of which are sources of acidity and diol functionalities, can be mixed with 30 gallons of water to effect treatment of onions. The described short-term wash treatment solution can be sprayed at a rate of 1 liter/min into the cutting chamber where onions are chopped at a rate of 200 pounds per hour. Clearly, there is a range of application rates that can be considered depending on the onion feed rate and the specific configuration of the equipment. It is important that the solution contact the onion close to simultaneously with the cutting because delays allow time for lachrymator generation. The duration of treatment and the time to removal of the solution is not of particular importance. In this reduction to practice, according to a case, it may be convenient to go directly from the chopper to flume wash system given treatment times of a couple seconds.

According to one or more embodiments, strong oxidants such as electrolyzed water or plasma activated water and other active oxygen species such as ozone or peroxides can be used at higher concentrations for short treatments which are too aggressive for extended exposure. These treatments are readily quenched by dilution in the main wash system. Therefore, the short-term wash treatment can include one or more of these strong oxidants.

It should be apparent from the foregoing that embodiments of an invention having significant advantages have been provided. While the embodiments are shown in only a few forms, the embodiments are not limited but are susceptible to various changes and modifications without departing from the spirit thereof.

For example, in an alternative embodiment, a produce wash system including a process stream including a short-term wash device followed by a wash device, a short-term wash treatment that is applied by the short-term wash device to a product, wherein the short-term wash treatment remains on the product for a pretreatment time that lasts until the product reaches the wash device, and a wash treatment that is applied by the wash device to the product, wherein the wash treatment rinses the short-term wash treatment from the product defining the end of the pretreatment time. The pretreatment time is set at or below a damage threshold time beyond which the short-term wash treatment damages the product beyond a damage threshold.

The short-term wash treatment may provide at least one or more from a group consisting of antimicrobial properties, potentiating properties for the antimicrobial action of the subsequent wash device and wash treatment, and controlling properties for controlling lachrymator release from the produce.

In another embodiment, the product may be fresh produce that is at least one selected from a group consisting of whole, sliced, cut, and chopped leafy greens including but not limited to lettuce, spinach, cabbage, and kale, and vegetables including but not limited to broccoli, onions, bell peppers, and squash.

In another embodiment, the product may be a meat product that is at least one selected from a group consisting of beef, pork, lamb, veal, game, and poultry that includes but is not limited to whole, parted, and boned poultry.

In another embodiment, the short-term wash device includes a spray device that is configured to spray the short-term wash treatment on the product.

In another embodiment, the short-term wash device may further include at least one from a group consisting of a rotating drum short-term wash device, an air column short-term wash device, a slicer/dicer device, a spray curtain, a shaker, and a timing belt, wherein the spray device may be integrated with the at least one from the group to spray the short-term wash treatment on the product.

In another embodiment, the short-term wash device may include a product submersing device that is configured to receive and submerse the product into the short-term wash treatment followed by the product being sifted out of the short-term wash treatment.

In another embodiment, the product submersing device may be at least one selected from of a group consisting of a rotating drum short-term wash device, a submersing pool pretreatment device, an agitating pool pretreatment device, and a spray curtain with brushes.

In another embodiment, the short-term wash treatment may include an acidulant and a polyol. The acidulant may be one selected from a group consisting of a phosphoric acid and lactic acid, and the acidulant is from 0.1% to 10% of the short-term wash treatment, and the polyol maybe one selected from a group consisting of a glycerin and a propylene glycol, and the polyol is from 0.1% to 10% of the short-term wash treatment.

In another embodiment, the pretreatment time the short-term wash treatment remains on the product may be between 3 seconds and 1.5 minutes at a temperature between 30° F. and 50° F.

In another embodiment, the wash treatment may include free active chlorine from 2 to 40 ppm of the wash treatment, a compatible acidulant selected from a group consisting of phosphoric acid, citric acid, and lactic acid, and wherein the compatible acidulant is from 10 to 1000 ppm of the wash treatment, and a polyol selected from a group consisting of a glycerin and a propylene glycol, and wherein the polyol is from 2 to 500 ppm of the wash treatment.

In another embodiment, the short-term wash treatment may include a coordinating acid and silver ions, wherein the coordinating acid is one selected from a group consisting of a citric acid and a lactic acid and is from 3% to 5% of the short-term wash treatment, and wherein the silver ions are from 10 to 50 ppm of the short-term wash treatment.

In another embodiment, the pretreatment time the short-term wash treatment remains on the product may be between 3 seconds and 1.5 minutes at a temperature between 30° F. and 50° F.

In another embodiment, the wash treatment may include a compatible acidulant selected from a group consisting of phosphoric acid, citric acid, and lactic acid, wherein the compatible acidulant is from 10 to 1000 ppm of the wash treatment, a polyol selected from a group consisting of glycerin and propylene glycol, wherein the polyol is from 1 to 500 ppm of the wash treatment, free active chlorine from 2 to 40 ppm of the wash treatment, and chloride from 1 to 100 ppm of the wash treatment.

In another embodiment, the produce wash system may further include a transfer belt between the short-term wash device and the wash device, the transfer belt configured to serve as a drain scroll to recycle the short-term wash treatment, and a timing belt that is configured to help complete the pretreatment time.

In another embodiment, the short-term wash treatment and short-term wash device may be configured to account for at least one of product overload, inadequate chlorine in a flotation tank, and incomplete pH control.

In another embodiment, the short-term wash treatment may provide a supplemental wash lethality of greater than 1 log against microbes found on the product as compared to the lethality of the wash treatment in the wash system alone.

In another embodiment, there is provided a pre-rinse prior to the short-term wash treatment. This pre-rinse is positioned so as to prevent soil and debris from interfering with the short-term wash treatment or from being carried over into the wash system. It can be advantages to make this pre-rinse the last use of wash water prior to disposal. In another alternative embodiment, for example, there is provided a method of produce washing using a short-term wash device. The method includes processing a product through the short-term wash device followed by a wash device, applying a short-term wash treatment using the short-term wash device to the product such that the short-term wash treatment remains on the product for a pretreatment time that lasts until the product reaches the wash device, and applying a wash treatment using the wash device to the product such that the wash treatment rinses the short-term wash treatment from the product defining the end of the pretreatment time, wherein the pretreatment time is set at or below a damage threshold time beyond which the short-term wash treatment damages the product beyond a damage threshold. In another embodiment, applying a short-term wash treatment in done in the form of micrometer sized droplets using a spray device of the short-term wash device to the product such that the short-term wash treatment remains on the product for a pretreatment time that lasts until the product reaches the wash device.

In another alternative embodiment, for example, there is provided a short-term wash treatment that includes an acidulant selected from a group consisting of a phosphoric acid and lactic acid, wherein the acidulant is from 0.1% to 10% of the short-term wash treatment, and a polyol selected from a group consisting of a glycerin and a propylene glycol, wherein the polyol is from 0.1% to 10% of the short-term wash treatment, wherein a pretreatment time the short-term wash treatment remains on the product is between 3 seconds and 1.5 minutes at a temperature between 30° F. and 50° F.

### Systems and Methods for Controlling Water Used for Industrial Food Processing

According to one or more cases, a number of elements are included in a control system for a value added produce wash system. Some of these elements relate to monitoring water attributes while others relate to the performance of the monitoring system itself. Other elements relate to monitoring the status of the food process.

For example, in some cases, the control system may include at least two channels of monitoring. These channels provide control to allow control of a primary stage and secondary stage present in many wash systems. In some cases, one or more pH-monitoring devices for each stage may be provided. A pH-monitoring device can include an electrode that is suitable for a food contact situation. One or more coulometric chlorine electrodes for each stage may be provided in some cases. The effluent from such electrodes is often dumped rather than returned to use. In some cases, temperature monitoring for correcting pH measurements and chlorine measurements based on projected values of both when at that temperature may be provided.

In some cases, another element that may be included in an apparatus, system, and/or method for controlling a wash solution in a wash system for produce handling includes a relay to stop product feed if chlorine by weight in the solution is out of specification for either stage. Similarly, product feed may be halted if pH is outside of the desired range. In some cases, a wired or wireless full duplex data communication with basic trend monitoring and reporting may be provided. Further, in some cases, another element that can be included is a memory location for storing all or some of the collected data along with other indicators. The data stored can include a subset of select data that is being collected. For example, key data can be backed up locally with a USB flash drive.

According to one or more cases, an electrode fouling control system including filtration and specific fouling removal processes may be included. Fault trapping in data analysis, may be used to monitor the water flow by a pH electrode and a chlorine electrode. Additionally, in one or more embodiment, it may be useful to ensure that a fouling control device, for example a Clean-In-Place (CIP) air pressure device, is present and that water is circulating in the wash system.

In other cases, other fouling-control devices such as clean-in-place embodiments may be provided that include flushing an electrode/sensor with a liquid wash solution, such as an acid solution or some other food-safe cleaning agent. A single clean-in-place device may be provided that is connected to each electrode such that the device is able to provide the cleaning air/gas and/or liquid as described herein. In another case, the clean-in-place device may be configured such that it can be connected when needed and disconnected from each electrode/sensor when not needed. In another case, each electrode/sensor may have its own specific clean-in-place device connected to the electrode/sensor. The clean-in-place device may therefore contain cleaning solution that is specifically tailored for the electrode/sensor. Further the device may further provide the ability to also provide a calibration solution when selected. Additionally, in some cases, when the clean-in-place device provides pressurized air/gas for cleaning, the pressure can be tailored specifically for the electrode/sensor to which the device is connected.

According to one or more cases, one or more touch screen interfaces can be provided for user input in the wet environment of a plant and allows substantial flexibility in input locations. Alternatively, a traditional mouse and/or keyboard can be provided. Further, microphones could be provided to capture audio commands and/or cameras can be included to capture user gestures that can correspond to select inputs and defined by the user and understood by the system.

According to some cases, another element that can be included is a relay that stops chlorine addition of the pH exceeds a threshold. For example, a facility safety is enhanced if there is a relay provided that can stop chlorine addition if the pH exceeds 7, which can be defined as a domain outside of the normal operating conditions. Similarly, one can set a lower bound to prevent or reduce the hazards of chlorine outgassing.

Further, additional elements can be included in the system and/or method for controlling a wash solution in a wash system for produce handling. For example, in accordance with one or more embodiments, sensor data and analysis data generated using the sensor data can be stored in memory somewhere in or connected to the system. Further, control signals and operational parameters can be generated and stored in memory as well. In accordance with one or more embodiments, a firewall panel is included in the system to allow external systems to view what is stored in the memory or database such as operational parameters without access to control features. Accordingly, the firewall panel can prevent unauthorized changes in operating parameters. In one or more cases, a memory coupled to at least one processor may be configured to store one or more of computer-readable instructions, one or more control signals, and one or more sensor signals.

A graphical user interface (GUI) may be shown on a computer display that a user, such as a machine operator, plant supervisor, etc., uses to view the data from the database, such as the sensor data and operational parameters. However, the firewall panel prevents the user from inputting control signals by discarding any input from the user that attempts to adjust the operational parameters and/or is detected by the firewall panel as a disallowed input.

A web portal interface may be provided to a user that is off-site, such as a customer or corporate company leadership. When the user connects using the web portal over the interne from a remote location in relation to the position of the system, the user is given certain privileges. For example, the user can be provided with access to view data stored in a database of the system. However, a firewall panel can be provided that disallows the user from inputting control commands that attempt to, for example, change the operational parameters of the system. Thus, the user can be granted viewer rights only through the use of the firewall panel. According to another embodiment, the firewall panel can provide some control of certain select items such requesting that the defouling of the sensors be executed, or that new data points be collected by the sensors and processed. In another embodiment, the firewall panel can prevent all action and only provide the user visual access.

A system and/or method for controlling a wash solution and pH deviations may be provided. A pH deviation includes using a pH sensor and a pH chemical pump. For example, a pH deviation to a desired value can be detected by the pH sensor. This data can then be analyzed to determine and generate a control signal that defines the operating parameters of a pH chemical pump. The signal is then transmitted to the pH chemical pump, which adjusts the amount of chemical based on the reviewed data in order to balance out the data from the sensor readings.

One or more sensors and controllers may be added to the product feed control loop to more stringently control the proceeding operations in accordance with one or more cases. Additionally, full feedback is reported to the controller about the status of product feed to ensure that the control relay is not circumvented and prevent inappropriate processing. The controller assesses whether the product feed is as expected given the status of the water chemistry.

A split line control may be provided in accordance with one or more cases. This element may allow the two control channels to control either a two-stage wash line, a one-stage wash line or two one-stage lines. According to other embodiments, additional channels can be included in excess of two.

According to one or more cases, a proportional integral derivative (PID) controller with, for example, 5 to 10 second control loops can be used to control the chemical pumps of the overall system. This allows the system to maintain the desired control and consistency in the water chemistry. The PID controller further allows for slow and fast acting sanitizer changes and better tuning of control. Further, according to one or more embodiments, controlling the speed of response provides the control system the ability to vary the degree of anticipation and response that corresponds with the produce wash equipment specification and/or produce characteristics. For example, cleaning carrots can sometimes be done with a longer response time to chemical amount shifts, while onions require a faster response to changes detected by one or more sensors. The control system can set the pump frequency and/or rate and stroke length to control the amount of chemical added, as well as the timing. Further, a time interval may be selected for pumping based on the sensor provided information.

A redundant transient storage solution may be provided that can provide data integrity and protection, in accordance with one or more cases. For example, a two-tiered backup solution can be implemented that uses local storage devices and a USB drive that can be plugged into any of the control system elements and then be moved and plugged into another element.

According to one or more cases, sensor fouling with limited interruption of data for cleaning may be provided that improves the fouling control system. According to one or more embodiments, a number of different elements can be provided that increase effectiveness. For example, switching from an elapsed time clock to a daily clock for chlorine electrode electrochemical cleaning can be provided. This change in clock cycle ensures that the chlorine electrodes may start each day of production without fouling. According to another embodiment, another element that can be provided is adding feedback to the controller to confirm that chlorine electrode was cleaned allowing verification rather than assuming the cleaning cycle was complete. Further, according to another embodiment another element that can be included is cascading a designed for purpose filter. This may include a set of cascading filters that may include a first filter connected in parallel with a second filter. These filters may be of a tangential flow design to extend operating time. This allows greater tolerance for interfering materials including fats and oils that are present in meat and poultry operations.

According to other cases, to increase the utility of the system and the cloud based data, more powerful analysis tools may be added and calibration data collected. According to one or more embodiments, a calibration report is generated to statistically guide the decision to adjust the output from the chlorine system to accurately report chlorine concentration without correction that just add noise to the data stream. The cloud data from multiple plants and lines allows development of metric for performance comparisons such as degree of control, hours of in control operation and the absence of outliers. According to another embodiment, the cloud based data can be used to generate certificates of performance to demonstrate that the line was operating correctly.

Given the importance of particle removal to fouling control of the electrodes, it is instructive to examine the filtration in greater detail that can be provided in accordance with one or more embodiments. For example, according to one or more embodiments, the filter housing and design look familiar but the fluid flow has been changed to provide by-pass flow to continuously clear the faces of the screens and filters as shown in FIG. 10 below. According to one or more embodiments, when filters of this type are cascaded, the filters are even more effective and provide longer operating windows before cleaning is indicated. This filtration coupled with clean-in-place (CIP) airflow, or another clean-in-place device, is enough to maintain the pH electrodes. The coulometric chlorine electrode may implicate electrochemical cleaning.

In accordance with one or more embodiments, the improved calibration process uses a calibration and verification process to ensure the accuracy of the sensor electrodes. Further, according to one or more embodiments, a new controller can be put into service when the electrode response has drifted to outside of the acceptable range as determined by the verification process which utilizes a t-test as a decision-making tool (the ratio of the difference to variance corrected for the number of measurements). This data can be manually entered into the cloud data system where the reporting decision reports the results reducing the human decisions.

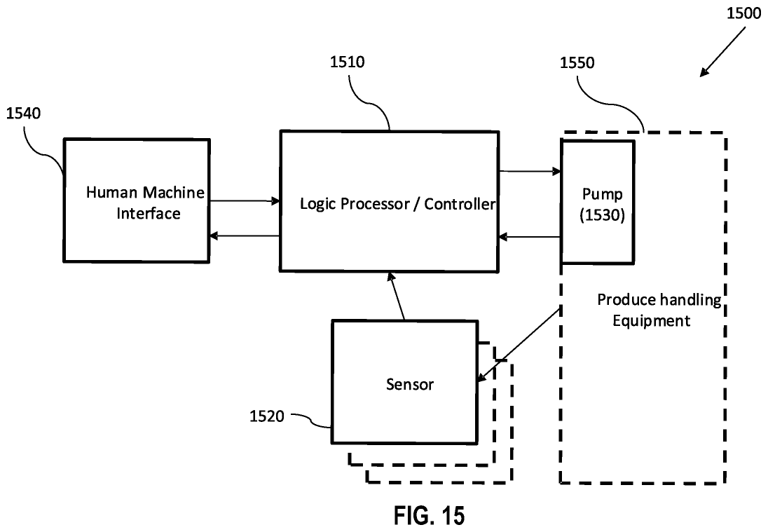

FIG. 15 is a block diagram of a control system 1500 for water used in produce processing, which may be called a water control system or an Automated Smart Wash Analytical Platform (ASAP), and produce wash equipment, which may also be referred to herein as a produce-handling device or produce-handling equipment 1550, in accordance with one or more embodiments. As shown a control system 1500 includes a logic processor 1510 that can also be called a controller 1510. The logic processor 1510 is provided to communicate and receive data from all the other elements of the control system 1500. The logic processor 1510 can also take the received data from other elements of the control system (such as the HMI 1540, sensor 1520, and pump 1530), or from devices at locations outside the control system 1500 (such as the produce-handling equipment 1550 or other external devices or databases). In accordance with one or more embodiments, the logic processor/controller 1510 can take any of the received data or subset thereof and process the data to generate analysis output that can be provided to the HMI 1540 for display to a user. Additionally the data can be used by the controller 1510 for generating control signals for controlling elements connected to the controller 1510.

For example, according to one or more embodiments, the logic processor 1510 receives sensor data from at least the sensor 1520, user input from the HMI 1540 from one or more users, and data from the pump 1530. The logic processor 1510 can also receive data from the produce-handling equipment 1550. Further the logic processor 1510 can also receive data from other control systems, or other databases. The logic processor 1510 then takes all or part of this received data and generates control signals that can be transmitted to one or more of the other elements of the control system 1500

Physically, the logic processor 1510 can be implemented using a select number of logic circuit elements that can be integrated into one or more other physical devices in the overall control system 1500 or even within an element of the produce-handling equipment 1550 or combination thereof. For example, a physical processing core can be integrated into the sensor 1520 or in the HMI 1540 that serves as the logic processor 1510. In another example, a processing core can be provided in the pump 1530 or in the produce-handling equipment 1550. In another embodiment the logic processor 1510 can be a stand-alone computing system. This can include but is not limited to an on-site server, an off-site server, a distributed server arrangement, a cloud computing system, a portable electronic device, and/or a combination.

The control system 1500 also include a human machine interface (HMI) 1540 that is connected to the logic processor 1510 such that the HMI 1540 can receive and provide data to and from a user and the logic processor 1510. The HMI 1540 can be for example, but is not limited to, a touchscreen, a monitor, a speaker system, a combination thereof, and/or any other device capable of transmitting and receives data from a user. For example, the HMI 1540 can be a stationary computer station, a mobile computing device such as a tablet, cellular phone, laptop, and/or wearable electronic. The HMI 1540 can also be a speaker system such as a stationary speaker system mounted in a facility or an integrated speaker system in an electronic device. Further, the HMI 1540 can be a combination of electronic display, sound, and camera devices. An HMI 1540 that includes one or more camera devices can receive inputs from a user in the form of gestures or movements. Also the HMI 1540 can include a microphone so that is can receive audio input from a user. Further, the HMI 1540 can receive input from the user using a keyboard, mouse, or touchscreen as well. The HMI 1540, when implements as a mobile device, can also receive input in the form of a movement, such as a shake or waving of the device by a user, that is detected by movement sensors in the mobile device. The HMI 1540 can then provide one or more of the received inputs to the logic processor 1510. Further, in another embodiment, the HMI 1540 can process the data and provide the results of the processing to the logic process 1510 in an effort to alleviate the processing load on the logic processor 1510.

The control system may include at least one sensor 1520. As shown, in other embodiments the control system 1500 can include a plurality of sensors. In one embodiment, the sensor 1520 can be a pH sensor that can detect a pH level in a fluid that is run through the sensor. The fluid can be the wash solution that includes water and possibly other chemical and debris from the produce-handling equipment 1550. In another embodiment, the sensor 1520 can be a chlorine sensor that detects a chlorine level in the fluid that is run through the sensor. Further, in other embodiments, the sensor 1520 can be a temperature gauge, a microphone, an imaging device such as a camera or video camera, or other known sensors. Further, a plurality of sensors can be included that can all be providing collected data to the logic processor 1510. The sensor 1520 can be provided elsewhere, near, adjacent to, attached to, and/or within the produce-handling equipment 1550. For example, the sensor 1520 can be located at a distance from the produce-handling equipment 1550 while being connected using a sampling hose that transports the fluid to be tested to the sensor 1520. In another embodiment, the sensor can be provided connected to or within the produce-handling equipment 1550.

Additionally, the control system 1500 may include at least one pump 1530. In other embodiments, the control system 1500 and include a plurality of pumps. The pump 1530 can be a chemical pump that pumps a select wash solution into the water of the produce-handling equipment that is being used to wash produce being processed. For example, the pump 1530 can be a pH solution pump, or in another embodiment a chlorine pump. The pump 1530 can also pump a wash solution that includes a number of chemical. The pump 1530 receives control signals from the logic controller 1510 that indicate to the pump when to pump, for how long to pump, and how fast the pump should operate.

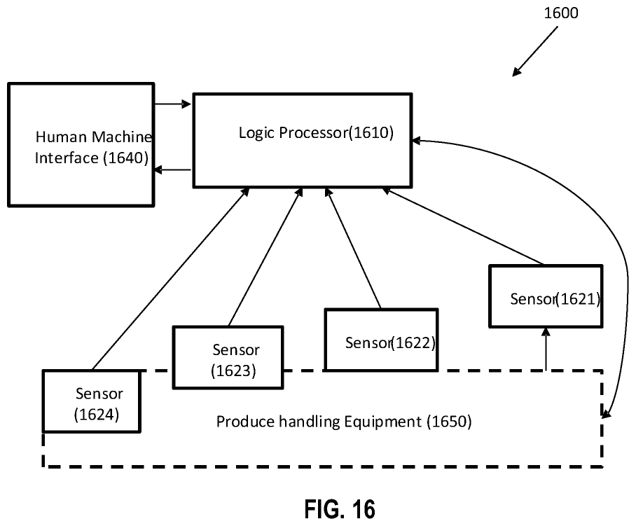

FIG. 16 is a block diagram of a control system 1600, or ASAP, for water used in produce processing with examples of sensor placement in accordance with one or more embodiments. As shown, the control system 1600 includes a logic processor 1610 that is connected to a human machine interface 1640 as well as a plurality of sensors 1621, 1622, 1623, and 1624. The sensors 1621, 1622, 1623, and 1624 are each shown at a different representative location in relation to produce-handling equipment 1650 that the sensors 1621, 1622, 1623, and 1624 are monitoring. The sensors 1621, 1622, 1623, and 1624 can be placed as shown at all different locations, all at any one position, or a combination thereof

Looking specifically at each of the sensors, a sensor 1621 can be provided away from the produce-handling equipment 1650. For example, a pH or chlorine sensor can be placed at a location and be connected to the equipment 1650 using a sampling hose that carries water from the equipment 1650 to the sensor 1621. In another embodiment, the sensor 1621 can be a camera or microphone. This arrangement allows for the control system 1600 to be provided at a central testing location to be installed in a plant setting away from any of the produce-handling equipment lines in the plant. Sensor 1622 can be placed adjacent to or connected to the produce-handling equipment 1650. For example, a sensor can be mounted on the outside of the produce-handling equipment were the sensor 1622 can be directly provided samples or inputs for testing. The sensor 1623 is provided such that part of the sensor can extend into the produce-handling equipment 1650. For example, sensor 1623 can be mostly mounted to an outer surface of the produce wash equipment with a probe extending into the equipment 1650. Further, sensor 1624 shows that a sensor can be provided completely within or submerged in the produce-handling equipment 1650.

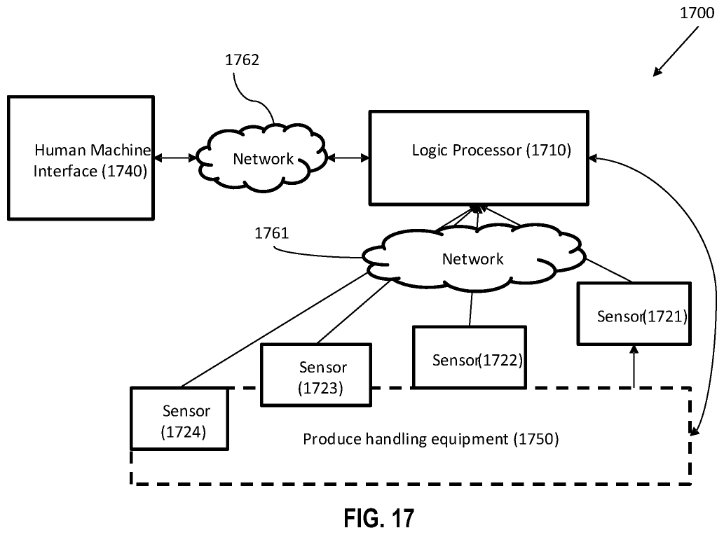

FIG. 17 is a block diagram of a control system 1700, or ASAP, for water used in produce processing showing examples of network integration in accordance with one or more embodiments. As shown the control system 1700 includes a logic processor 1710, a HMI 1740, and sensors 1721, 1722, 1723, and 1724 provided to collect data from produce-handling equipment 1750. Similarly, sensors 1721, 1722, 1723, and 1724 are similar to sensors 1621, 1622, 1623, and 1624 of FIG. 16. Further, the control system now includes one or more networks 1761 and 1761 that can be used to connect elements of the control system 1700 that are no longer directly connected with the logic processor 1710. Specifically, as shown, a network 1761 can be used to connect sensors 1721, 1722, 1723, and 1724 to the logic processor 1710. For example, the network 1761 can include a local area network (LAN) and associated device resources that provide a communication path for the sensors to communicate with the logic processor. The network 1761 can be a wired system, a wireless system, or a combination thereof. The network 1761 can also be a wide area network (WAN) or can represent a connection through the internet that would traverse a number of network elements now included in the network 1761. This allows for the placement of the logic processor 1710 to effectively be placed anywhere.

Further, the system 1700 includes a network 1762 that connects the HMI 1740 and the logic processor 1710. The network 1762 can include a local area network (LAN) and associated device resources that provide a communication path for the HMI 1740 to communicate with the logic processor. The network 1762 can be a wired system, a wireless system, or a combination thereof. The network 1762 can also be a wide area network (WAN) or can represent a connection through the internet that would traverse a number of network elements now included in the network 1762. This allows for the placement of the logic processor 1710 and the HMI 1740 to effectively be placed anywhere. For example, the HMI 1740 could be a portable electronic device that the user carries within the plant or outside the plant. Similarly, the logic processor 1710 can be located on-site, off-site, or a combination thereof.

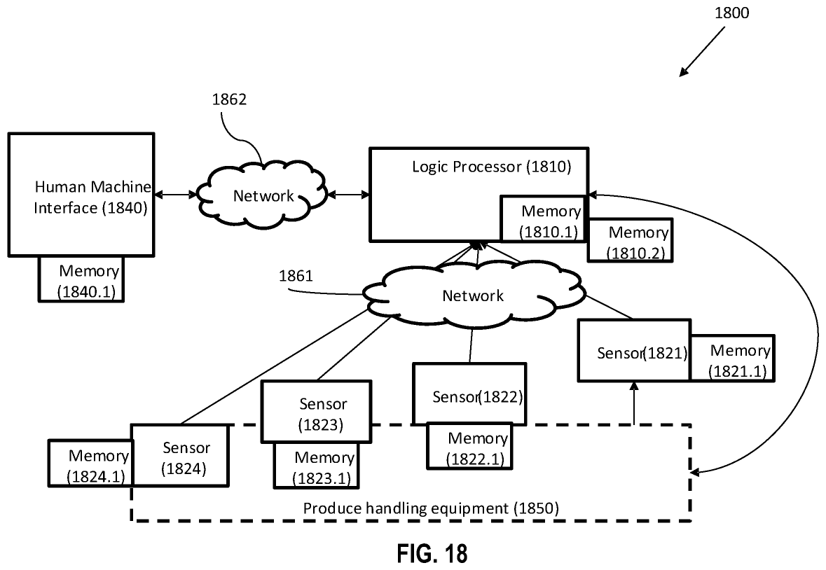

FIG. 18 is a block diagram of a control system 1800, or ASAP, for water used in produce processing with examples of data storage memory locations in accordance with one or more embodiments. The control system 1800 includes a HMI 1840, a logic processor 1810, sensors 1821, 1822, 1823, and 1824, and networks 1861 and 1862 that are similar to the similar elements in FIGS. 16 and 17. Specifically, the HMI 1640, logic processor 11610, sensors 1621, 1622, 1623, and 1624 from FIG. 16 and networks 1761 and 1762 from FIG. 17, respectively.

Further, the control system can include one or more of the shown memory devices or locations. The memory devices can be provided in the form of integrated random access memory (RAM), read-only memory (ROM), a cache, or any other known memory arrangement. These integrated memory elements can be provided as, for example, a static integrated circuit, a hard drives, floppy disc, optical drive, or any other known memory type. Further, the memory devices can also be stand along memory devices in the form of USB data drives or external hard drives or even distributed cloud computing storage solutions. For example, looking specifically at FIG. 18, the HMI 1840 can include a memory device 1840.1. This memory device 1840.1 can be a universal serial bus (USB) thumb drive, an integrated or external hard drive, or any other memory device and/or combination thereof. Additionally, according to one or more embodiments, control system 1800 elements can include a plurality of memory devices. For example, the logic processor 1810 can include a first memory device 1810.1 and can also include a second external memory device 1810.2. The first memory device 1810.1 can be an internal form of memory while the second memory device 1810.2 can be an external memory device such as a USB thumb drive. Further, according to one or more embodiments, any one of the sensors 1821, 1822, 1823, and 1824 can each also include one or more forms of memory devices 1821.1, 1822.1, 1823.1, and 1824.1 as shown. Further, according to one or more embodiments, an external detachable memory element, such as a USB thumb drive 1821.1, can be detached from a sensor 1821 and can then be directly connected to another device such as the logic processor 1810 transferring the data from the memory device 1821.1 to the logic processor 1810. This process can also be done in the reverse carrying data such as control signals to a sensor or other device in the system.

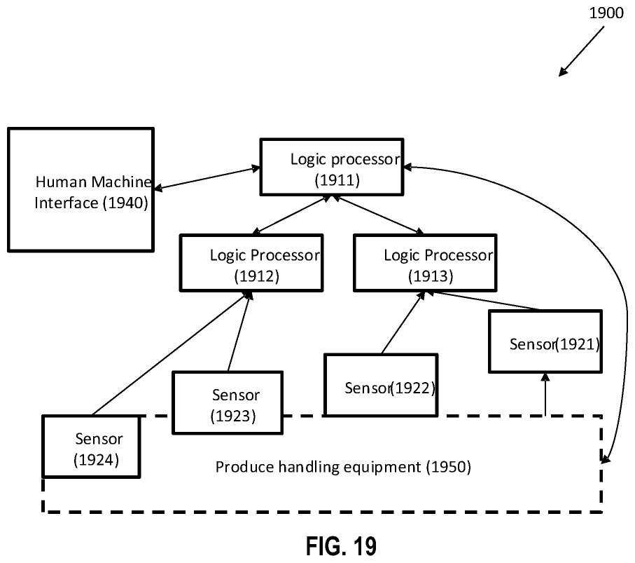

FIG. 19 is a block diagram of a control system 1900, or ASAP, for water used in produce processing with distributed processing control in accordance with one or more embodiments. The control system 1900 includes a HMI 1940, and sensors 1921, 1922, 1923, and 1924. In other embodiments the control system 1900 can have more or less sensors and their placement can also vary as well as their type. In this embodiment the logic processor/controller is explicitly show has a distributed system. Specifically the control system 1900 can include a number of logic processors 1911, 1912, and 1913. As shown the logic processor 1912 for example can handle a subset of the sensors. For example, the logic processor 1912 can be connected to chlorine sensors 1923 and 1924 in the system and can therefore conduct all the specific data processing associated with the type of sensor data. The logic processor 1913 is show to connect with a different subset of sensors. For example, the logic processor 1913 can connect to pH sensors 1922 and 1921 found in the system. The logic processors 1912 and 1913 can then send specifically processed data to the logic processor 1911 which can conduct additional overarching processing and send that to be displayed to a user using the HMI 1940.

According to other embodiments, there can be include more or less logic processors than those shown. For example each sensor can have its own logic processor or any variation thereof can be provided. Further, according to other embodiments, the logic processor 1912 and logic processor 1913 may connect to sensors not based on their type but rather another characteristic such as location or processing requirements to produce a specifically desired output.

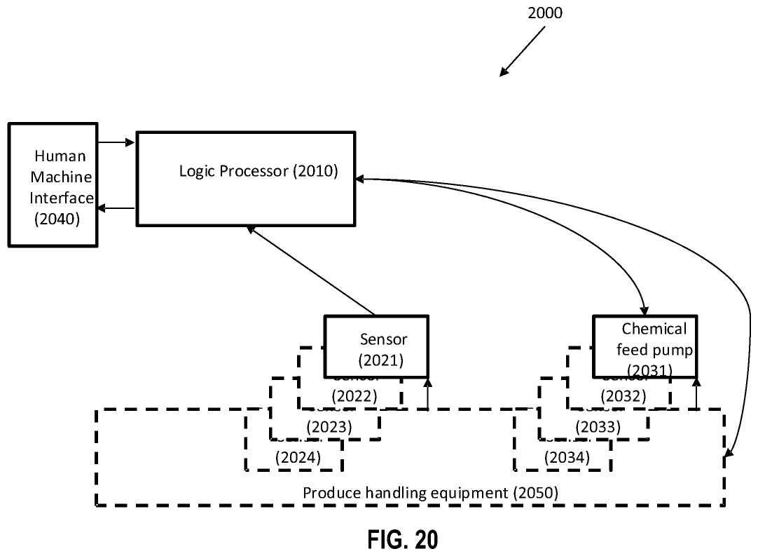

FIG. 20 is a block diagram of a control system 2000, or ASAP, for water used in produce processing including control signals and pumps that are controlled by the control signals in accordance with one or more embodiments. Specifically, as shown, the control system 2000 includes one or more pumps 2031, 2032, 2033, and 2034. According to one or more embodiments, the chemical feed pump 2031 can be provided away from, adjacent to, partially within, or totally within the produce-handling equipment 2050. Further, according to other embodiments, the pumps 2032, 2033, and 2034 can be provided at different locations, as well. One or more of the chemical pumps 2031, 2032, 2033, and 2034 can pump produce wash chemicals such as chlorine and/or a combination of chemicals that make up a wash solution. For example, a commercial system for a two-stage leafy green wash line might include six pumps to allow control of chlorine in each stage, and two additional pumps to control an acid wash adjuvant that is suitable for organic or conventional production allowing for ease in line conversion from organic to conventional production. The reverse conversion can also be done, but this conversion is less useful because a full wash-down may be implicated to prevent carryover into the organic production.

Further, the control system 2000 includes a logic processor 2010 that receives data from one or more sensors 2021, 2022, 2023, and 2024. The logic processor 2010 can also receive data from a HMI 2040. Further, the logic processor 2010 can receive data from one or more of the chemical feed pumps 2031, 2032, 2033, and 2034. The logic processor 2010 can then take all or part of the received data and process the data to come up with control signals. The control signals can then be transmitted to, for example, the chemical feed pumps instructing the pump on when and how much to pump. For example, consider a leafy green processing line operating at a 15 ppm by weight setpoint for the chlorine level in a wash solution. As the chlorine level begins to fall due to product flow and reaction, the controller will activate the chlorine pump. As the demand grows, the PID will begin anticipating the demand prompting greater and/or longer activation of the pump with the goal of maintaining a stable chlorine concentration in the wash system. Similar control will be exercised to control the pH.

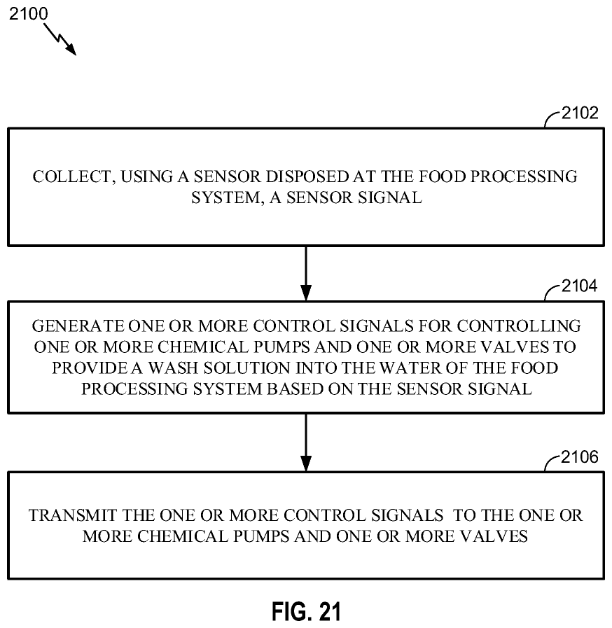

FIG. 21 is a flow chart of operations 2100 for using a control system for controlling water used in produce processing in accordance with one or more embodiments. The operations 2100 include collecting, using a sensor disposed at the food-processing system, a sensor signal (operation 2102). The operations 2100 also include generating one or more control signals for controlling one or more chemical pumps and one or more valves to provide a wash solution into the water of the food-processing system based on the sensor signal (operation 2104). The operations 2100 further include transmitting the one or more control signals to the one or more chemical pumps and one or more valves (operation 2106).

In spite of recent advances in wash process control as discussed herein, there are still challenges. The control systems as described herein may be operated in cold and/or wet environments. Such environments may be deleterious to the performance of electronic components. Failure of these potentially critical electronic components may present a potential food safety hazard. The control of the wash process is critical to many food-processing operations. Manual control is increasingly inadequate. Therefore, wash process control is increasingly handled by control systems such as described herein in one or more disclosed embodiments and examples. Further, additional features may be provided that may further improve and care for instrumentation as described herein that is used to manage wash processes.

In accordance with one or more cases, chlorine monitoring and maintenance may be improved through the implementation of, for example, calibration and/or electrode cleaning. The importance and mechanics of chlorine electrode calibration are described herein. However, chlorine electrodes and flow cells can be fouled by deposits that can vary from tan to black in color. These deposits can be cleaned manually by disassembly and manual scrubbing with an acid cleaner. Although this may be an adequate way to end up with a clean sensor, the process and needing to stop the produce processing and then remove, disassemble, reassemble, and then reinstall the sensor provides a number of issues and potential issues that one would rather avoid or minimize. For example, this is not only time consuming, but also costly and imposes both wear and tear on the sensor parts such as the electrodes as well as provides a complex disassemble/assemble procedure that may lead to erroneous implementation leading to sensor damage and possible food safety concerns.

### Systems and Methods for Providing a Variable Intensity Controller for a Short-term Intense Process

There are a number of elements that typically come together for a useful short-term intense process controller. These elements include product flow, treatment composition, treatment intensity, treatment delivery, and timing. A complete controller may regulate all these elements and verify compliance to the process parameters. However, lesser controllers may find applications where other features of the process can mitigate some of these needs. As a practical matter, the controller does not need to be housed in a single box, and the controller logic can be distributed between multiple physical devices that work in concert to achieve the desired level of control. Each of these elements is examined individually prior to examining specific embodiments which include examples where portions of the controller are placed in other devices. For example, in accordance with one or more cases, a separate controller device may be added in addition to, and separate from the controllers and logic shown in FIGS. 15-20. Alternatively, the controller for controlling a short-term wash solution may be included in the shown logic processors and/or controllers shown in FIGS. 15-20.

As used herein, the phrases “short-term intense treatment,” “short-term wash treatment,” and “intense prewash treatment” generally refer to a sanitation process for a food product with enhanced microbial lethality (compared to a regular wash treatment) that is time-limited (e.g., 1.5 minutes or less) to prevent the sanitation process from damaging the food product, or to a wash solution used in the corresponding time-limited sanitation process. Examples of this wash solution include, but are not limited to: a combined solution of about 6% phosphoric acid and about 2.5% propylene glycol; other combinations of acids and simple polyols; solutions including an acid without a polyol, particularly citric, lactic, or acetic acids; 10-50 ppm silver dihydrogen citrate in a 3-5% citric acid solution; a mixture of silver dihydrogen citrate, an acid, and a polyol, such as a dilution of silver dihydrogen in a lactic acid glycerin solution; a solution of 0.05 to 0.25% bisulfate in dilute acid with a diol or other small polyol; or any solution including 0.1 to 10% of an acidulant (e.g., phosphoric acid or lactic acid) and 0.1 to 10% of a polyol (e.g., glycerin or propylene glycol).

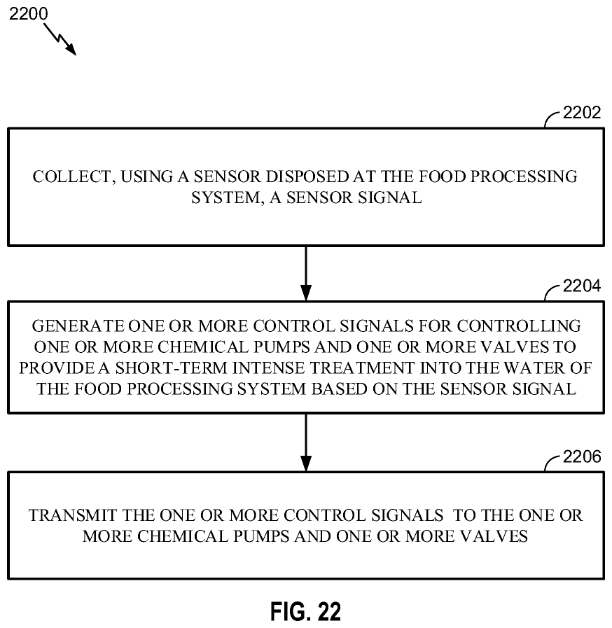

FIG. 22 is a flow chart of operations 2200 for using a control system for controlling a short-term intense treatment used in produce processing in accordance with one or more embodiments. The operations 2200 include collecting, using a sensor disposed at the food-processing system, a sensor signal (operation 2202). The operations 2200 also include generating one or more control signals for controlling one or more chemical pumps and one or more valves to provide a short-term intense treatment into the water of the food-processing system based on the sensor signal (operation 2204). The operations 2200 further include transmitting the one or more control signals to the one or more chemical pumps and one or more valves (operation 2206).

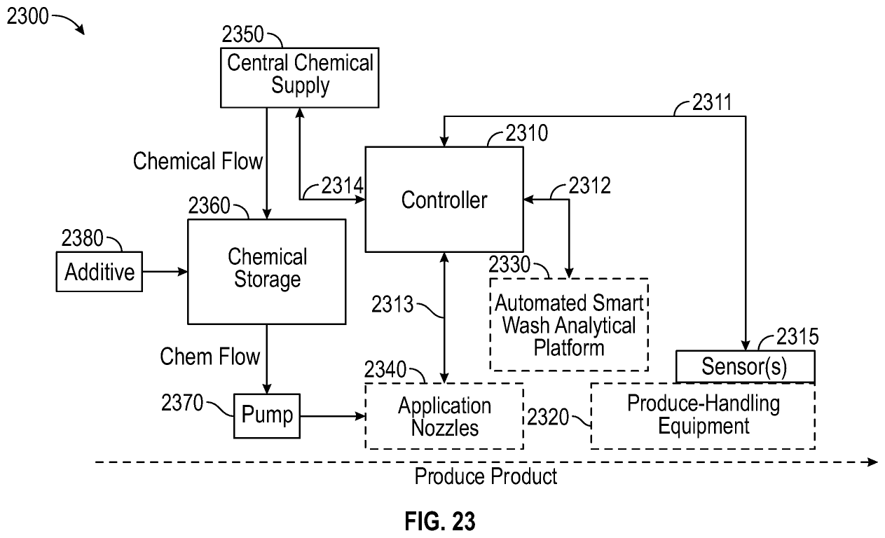

FIG. 23 is a block diagram of a control system 2300 for controlling a short-term treatment, in accordance with certain aspects of the present disclosure. As shown the system 2300 may include a controller 2310 that is configured to communicate with one or more other elements in the system. For example, in some cases, the controller may receive a communication 2311 from one more sensors 2315 that are positioned to collect and/or generate sensor readings based on produce-handling equipment 2320. In some cases, the controller 2310 may send a communication 2312 to an ASAP 2330 that provides information about the produce-handling equipment 2320 as well. Further, the controller may exchange control information 2313 with application nozzle(s) 2340. This information may instruct the nozzles 2340 about how much, when, and/or when to spray produce product that passes by. Further, the controller 2310 may exchange control information 2314 with a central chemical supply (2350) which can provide a select chemical flow to a chemical storage (2360) along with an additive 2380 in some cases. The chemical storage 2360 may then be configured to provide a chemical flow to the application nozzles 2340 using a pump 2370 as shown.

In accordance with one or more cases, there may be at least two related aspects to product flow that may be taken into consideration when determining how to control a short-term wash solution. In particular, product flow can be on or off, and it also has an intensity or amount of flow. A controller can be used to start and stop the flow of the short-term treatment agent or material to match the flow of product to avoid wasting the treatment material. The input for this control function can be achieved with a sensor to detect the presence or absence of product on the feed conveyance, by monitoring the status of the conveyance system or both depending on the degree of certainty needed. The more expensive the treatment agent, the more effort that is appropriate to apply to avoid waste by attempting to adjust the treatment agent when product is not present. The case where product flow is either over or under the appropriate feed rate is a separate case. In either of these conditions, it may be appropriate to call for intervention for correction with an alarm or to pass this information to the feed conveyance system for correction. In some process lines, this type of control loop will already exist, and the logic of the intense short-term process controller need only communicate with the existing systems.

In one or more cases, the treatment agent composition used for a short-term intense process may be considered to be a critical element that should be monitored and adjusted to allow for managing the overall wash process. In particular, in some cases, a short-term intense process is critical to the desired wash process, so it is important to ensure that the desired composition is delivered. For example, if an acidulant is used to potentiate the action of an antimicrobial, it would be appropriate to have a sensor (e.g., a pH electrode) to ensure the desired pH was achieved. It would also be appropriate to have a sensor to ensure that the antimicrobial is present. For example, as provided in FIGS. 15-20, there will be cases where this function is housed in a separate device, but it is still part of controlling the intense process. In some cases, where a single blending station is used to prepare the treatment agent for multiple lines, the system may only include this verification equipment after the blending station and not on every line assuming the distribution system reliably delivers the material. Given that the distribution system is most likely pipes or tubing, this reliability can be easily confirmed with manual methods when the system is commissioned. It is important that the sensors suite developed be appropriate for the material to be controlled.

In accordance with one or more cases, other compositional components for a short-term intense treatment are disclosed in FIGS. 1-14 and can include various antimicrobial oxidants such as peroxyacetic acid, ozone, hydroperoxide, and the various forms and oxidations states of chlorine. Silver ions are another oxidant that proves useful. The types of components can be monitored with various sensors and electrodes to ensure that the desired composition is delivered.

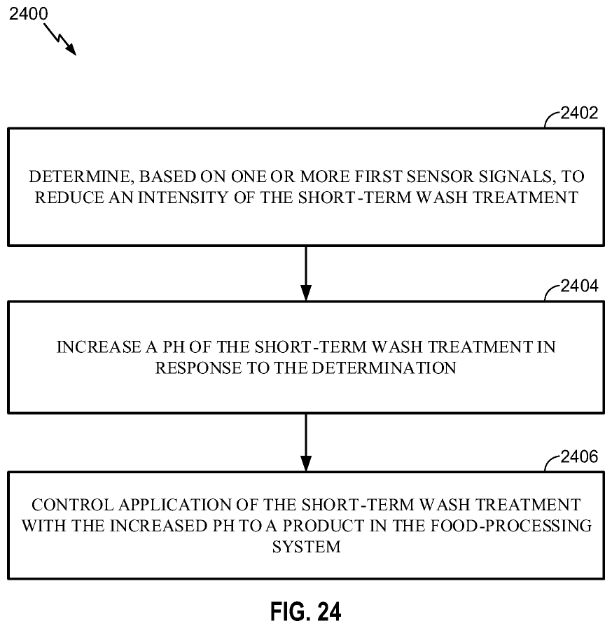

FIG. 24 is a flow chart of operations 2400 for controlling a short-term wash treatment used in a food-processing system, in accordance with one or more embodiments. The operations 2400 include determining, based on one or more first sensor signals, to reduce an intensity of the short-term wash treatment (block 2402). The operations 2400 also include increasing a pH of the short-term wash treatment in response to the determination (block 2404). The operations 2400 further include controlling application of the short-term wash treatment with the increased pH to a product in the food-processing system (block 2406).

According to certain aspects, the one or more first sensor signals include at least one of a first signal indicating a cutter of the food-processing system is on, a second signal indicating presence of the product on a product feed belt of the food-processing system, or a third signal indicating a speed of the product feed belt.

According to certain aspects, the one or more first sensor signals comprise at least one of a first signal indicating the pH of the short-term wash treatment prior to increasing the pH of the short-term wash treatment, a second signal indicating a concentration of silver ions in the short-term wash treatment, or a third signal indicating a flow rate of the short-term wash treatment to one or more applicators of the food-processing system. For example, the one or more first sensor signals may comprise the first signal that indicates the pH of the short-term wash treatment is 2.1±0.1. In this case, increasing the pH of the short-term wash treatment may involve increasing the pH of the short-term wash treatment to 2.5±0.1.

According to certain aspects, increasing the pH of the short-term wash treatment includes activating a dosing pump to add sodium hydroxide (NaOH) to the short-term wash treatment.

According to certain aspects, increasing the pH of the short-term wash treatment entails activating a supply pump to increase a flow rate of water in the food-processing system.

According to certain aspects, the operations 2400 further include deciding, based on one or more second sensor signals, to increase the intensity of the short-term wash treatment; decreasing the pH of the short-term wash treatment in response to the decision; and controlling application of the short-term wash treatment with the decreased pH to additional product in the food-processing system. In this case, the one or more second sensor signals may include a signal indicating a speed of the product on a product feed belt of the food-processing system.

In one or more cases, the intensity of a short-term intense treatment is an important variable because one or more cases can take advantage of the greater tolerance for the treatment of the product than the offending pathogens. However, in some instances, the product will have variable tolerance to the treatment forcing the reduction in treatment intensity to maintain the desired quality. The ability to adjust the intensity without retooling allows titrating for the maximum treatment even when the product tolerance is reduced. The actual controls for the intense treatment intensity control will vary with the treatment composition. For acidity oxidants and for acidified silver, increasing the pH with an alkali such as the salt of a weak acid such as sodium acetate or sodium lactate can be beneficial. Other alkali agents such as sodium or potassium hydroxide can be used. It is important that chemistry of the treatment be preserved even as the intensity is reduced. The use of a phosphate salt with silver ions would be less desirable due to the interaction of the phosphate with the silver. As an alternative strategy, the concentration of the antimicrobial can be reduced, if the concentration is limiting the product quality. Controlling the treatment intensity calls for an understanding of the chemistry of the treatment.

In accordance with one or more cases, to affect this intensity of control, it may be desirable to have a feedback loop allowing the controller to make the desired adjustments to the treatment intensity. In accordance with one or more cases, this control can be implemented directly at the line, can be implemented under software control, and/or controlled remotely depending on the logic and processor power built into the controller or connected to the controller.

According to aspects of the present disclosure, one or more processes in the operations 2400 may be manual processes. That is, a human operator controlling the short-term wash treatment may determine (e.g., similar to block 2402) to increase pH of the short-term wash treatment without referring to a sensor signal. For example, the human operator may expose a litmus strip to the short-term wash treatment and determine to adjust the pH, or the human operator may observe that there is not product in the food-processing system. The human operator may manually increase the pH of the short-term wash treatment (e.g., similar to block 2404), for example, by manually adding a basic fluid or a neutral fluid to the short-term wash treatment. The human operator may manually control the application of the short-term wash treatment with the increased pH to a product in the food-processing system (e.g., similar to block 2406), for example, by manually operating a valve or sprayer.

In aspects of the present disclosure, one or more processes in the operations 2400 may be performed by a machine or a system of machines. That is, a machine, such as an ASAP, controlling the short-term wash treatment may determine (e.g., similar to block 2402) to increase the pH of the short-term wash treatment based on one or more sensor signals. For example, an ASAP may receive a sensor signal indicating a cutter of the food-processing system is on and determine to increase the pH of the short-term wash treatment. The ASAP may indicate to a human operator to increase the pH of the short-term wash treatment, and the human operator may manually increase the pH of the short-term wash treatment (e.g., similar to block 2404), for example, by manually adding a basic fluid or a neutral fluid to the short-term wash treatment. Additionally or alternatively, the ASAP may activate a dosing pump to add a basic solution (e.g., a sodium hydroxide (NaOH) solution) to the short-term wash treatment. The ASAP may control the application of the short-term wash treatment with the increased pH to a product in the food-processing system (e.g., similar to block 2406), for example, by sending a control signal to operate a valve or a supply pump pumping the short-term wash treatment to applicators (e.g., sprayers) in the food-processing system.

In one or more cases, treatment delivery is generally affected by spray application in a cutting operation. Care should be taken to ensure that any fan or blower activity of the cutting blades does not prevent intimate contact of the treatment with the product. Other configurations that do not involve a cutting device have been beneficial including dips and fluidized beds. Given the intensity of the treatment and the need for contact time control, it is generally important to ensure plug flow through or passed the delivery appliance. Thus, treatment delivery and time can be closely linked.

In one or more cases, avoiding over and/or excessive treatment time or intensity by ensuring that product is not stopped in process is critical to commercial success. Thus a timing system may be provided that can ensure that treated product is conveyed to the quenching step without violating the process parameters.

In accordance with one or more cases, one or more interventions can be implemented that provide for a form of control for a short-term intense treatment. In particular, the treatment composition can be mixed manually, for example an appropriate amount of one or more wash solutions can be mixed along with water to yield an intense antimicrobial solution. The pH can be adjusted as needed with sodium hydroxide as desired. The composition of this blend can be analyzed with the usual analytical tools or with specialized sensors to confirm the composition if desired but the most accurate approach is to ensure the proper components are mixed. The unadjusted mixes have pH values around 2.1, but the intensity can be reduced by increasing the pH, usually to about 2.5, but higher pH values have been used. A spray apparatus in the cutter is connected to pressure gauge with a simple valve-controlled bypass to regulate flow rate with a manual switch to start and stop the pump. The operator should ensure that product does not rest on a time belt. The operator can provide documentation as desired for validation. Logs of chemical usage and operating pressures are typical. Quality assurance may also consider records of the compositional assays done to ensure conformance to process. Thus, with a number of interventions, all of the elements of control can be achieved.

In accordance with one or more cases, a system minimizing the reliance on the many interventions as described can be assembled as follows to control a high intensity treatment. In some cases, the same composition may be used, but other compositions may also be used in accordance with other cases.

In some cases, one controller for each cutter may be provided. Further, a main header or other system may be provided and used to deliver a base process short term chemical to the controller. For example, this base process short term chemical may be a pre-blended mix of two or more wash solutions. Proportioning valves may also be provided. Further, a main header or other delivery system may initially not be pressurized to 50 psi. Rather, the controller may be used to increase pressure to the 50 psi operating level. This controls for the ability to operate the application during a determined desired time and location. For example, in some cases, one may only want sprayers to operate when: a Cutter is ON, Product Feed Belt is ON, and Product is on the Feed Belt.

In accordance with one or more cases, various sensors and connections to the lines may generate a number of inputs that are to be directed to the controller including but not limited to one or more digital inputs and/or one or more analog inputs. The digital inputs may include, for example, a “Cutter ON” Signal, a “Product On Belt” signal, or a “Product Feed Belt ON” Signal. The Cutter ON Signal may include, for example, RPM value(s) from the cutter and/or the cutter motor. The Product ON Belt signal may be generating using an optical camera. In another case the Product ON Belt signal may be generated using a weight sensor. The one or more analog inputs may include, for example, a pH Measurement, a Silver Ion Measurement from an applicable electrode, a Flow Rate to Sprayers, a psi to Sprayers, or a Belt Speed Indicator(s). In some cases the Belt Speed Indicator(s) may include information about one or more of a timing belt and/or a treatment belt speed.

In accordance with one or more cases, based on the rules of operation, the controller may process the inputs to generate outputs to control the short-term intense process that may include digital outputs and/or one or more analog outputs.

The digital outputs may include, for example, a digital signal that opens a process boost chemical supply solenoid, a digital signal that turns ON a process boost chemical booster and/or supply pump, or a digital signal that activates a chemical dosing pump to increase pH or may provide other chemical balancing.

The analog outputs may include, for example, an analog signal that activates a chemical dosing pump to increase pH (preferred control for peristaltic type pump), an analog signal that can increase and/or decrease a Booster and/or Supply Pump pressure.

It should be noted that in some cases the difference between analog and digital signals may be increasingly blurred as the cost for digital logic falls. Changing an input or output from one category to another is largely a matter of convenience based on the specific components that are selected. Accordingly, one or more such cases may lead to a number of devices that need to be included:

For example, in accordance with one or more cases, a Photo Eye for “seeing” Product on Feed Belt may be included. Further, a Supply Solenoid for “base” Process Boost Chemical may be included. In some cases, a Booster/Supply Pump to increase fluid pressure to 50 psi (dependent on outcome of pressure-based treatment test) may be provided. In some cases, a sensor to detect belt speed can be provided. In some cases, a Dosing Pump to add NaOH may be utilized. In such cases, a peristaltic pump is used due to low dosing specifications. Further, in some cases, one or more electrodes and/or sensors may be provided such as a pH sensor, a silver ion electrode, a psi sensor, and/or a flow rate sensor.

In accordance with one or more cases, with the assembled system, there are some operating states that define the rules of operation. This list includes: a System in MANUAL state, a Supply Solenoid is OFF state, a Dosing Pump is OFF state, and a Booster Pump is OFF state.

In some cases, a system may be in an AUTO state, and a Photo Eye shows No Product OR a Cutter Signal is off or a Feed Belt Signal is off. In this state the following parameters may be implemented including setting a Supply Solenoid OFF (Closed), a Dosing Pump turns OFF, and a Booster Pump turns OFF.

In some cases, a system may be in AUTO state, and a Photo Eye shows Yes Product AND Cutter Signal is On AND Feed Belt Signal is On. In this state the following parameters may be implemented including setting a Supply Solenoid ON (Open), a Dosing Pump turns ON (as utilized to control pH), and a Booster Pump turns ON (as utilized to meet psi specification).

There are also conditions that indicate that something unexpected or undesirable is occurring. These may be fault conditions that will generally call for an intervention. These include for example a number of different possible setpoints. For example, for pH, setpoints may include Control Set Point, High Alarm, and Low Alarm. For Silver Ion, setpoints may include High Alarm and Low Alarm. In such cases dealing with silver ion, a level may be controlled by a blending station, and alarms may or may not make sense depending on the implementation. For psi, setpoints may include Set Point, High Alarm, and Low Alarm. For Flow Rate, setpoints may include Set Point, High Alarm, and Low Alarm. In such cases dealing with flow rate, the system may be controlled by psi and a number of nozzles, and in some cases the system may only use as an operational monitor.

In one or more cases, given that the cost of logic is declining and the potential to improve operating performance, there are some additional items that can be considered when building a controller. For example one such item may include Adding a Low Pressure shut-off. If the fluid pressure after the booster pump drops very low, a cut-off of chemical supply due to possible rupture may be provided. Another such item may include adding a psi sensor before a Supply Solenoid to confirm main header pressure (chemical being supplied). Another item may include adding Static Mixer to system piping to aid in mixing of NaOH into the Process Boost chemical before pH measurement. Another item may include adding the ability to turn off “Product on Belt” and “Product Feed Belt ON” Signals for sprayer activation, for facilities that hand feed cutters. Another item that may be included is adding independent communication to a plant data system or control room. Another item includes adding communication link to other control systems involved in the process. For example, communications links may be added to wash lines, feed belts, wash water panels, and other controllers.

These improvements can be used in tandem or individually to improve the reliability of wash process control equipment.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to a case or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof.

Therefore, it is intended that the present disclosure not be limited to the particular embodiment disclosed as the best mode contemplated for carrying out this present disclosure, but that the present disclosure will include all embodiments falling within the scope of the claims.

1. A method for controlling a short-term wash treatment used in a food-processing system, comprising:
determining, based on one or more first sensor signals, to reduce an intensity of the short-term wash treatment;
increasing a pH of the short-term wash treatment in response to the determination; and
controlling application of the short-term wash treatment with the increased pH to a product in the food-processing system.

2. The method of claim 1, wherein the one or more first sensor signals comprise at least one of a first signal indicating a cutter of the food-processing system is on, a second signal indicating presence of the product on a product feed belt of the food-processing system, or a third signal indicating a speed of the product feed belt.

3. The method of claim 1, wherein the one or more first sensor signals comprise at least one of a first signal indicating the pH of the short-term wash treatment prior to increasing the pH of the short-term wash treatment, a second signal indicating a concentration of silver ions in the short-term wash treatment, or a third signal indicating a flow rate of the short-term wash treatment to one or more applicators of the food-processing system.

4. The method of claim 3, wherein:
the one or more first sensor signals comprise the first signal that indicates the pH of the short-term wash treatment is 2.1±0.1; and
increasing the pH of the short-term wash treatment comprises increasing the pH of the short-term wash treatment to 2.5±0.1.

5. The method of claim 1, wherein increasing the pH of the short-term wash treatment comprises activating a dosing pump to add sodium hydroxide (NaOH) to the short-term wash treatment.

6. The method of claim 1, wherein increasing the pH of the short-term wash treatment comprises activating a supply pump to increase a flow rate of water in the food-processing system.

7. The method of claim 1, further comprising:
deciding, based on one or more second sensor signals, to increase the intensity of the short-term wash treatment;
decreasing the pH of the short-term wash treatment in response to the decision; and
controlling application of the short-term wash treatment with the decreased pH to additional product in the food-processing system.

8. The method of claim 7, wherein the one or more second sensor signals comprise a signal indicating a speed of the product on a product feed belt of the food-processing system.

9. A control system for controlling a short-term wash treatment used in a food-processing system, the control system comprising:
an interface configured to receive one or more first sensor signals from the food-processing system; and
a processing system coupled to the interface and configured to:
determine, based on the one or more first sensor signals, to reduce an intensity of the short-term wash treatment;
generate a first control signal to cause an increase in a pH of the short-term wash treatment in response to the determination; and
control application of the short-term wash treatment with the increased pH to a product in the food-processing system.

10. The control system of claim 9, further comprising:
a human machine interface (HMI) configured to display information from the processing system to a user.

11. The control system of claim 9, wherein the processing system is configured to control application of the short-term wash treatment with the increased pH by generating a second control signal based on the one or more sensor signals and wherein the control system further comprises at least one pump that is configured to:
receive the second control signal; and
pump the short-term wash treatment into the food-processing system based on the second control signal.

12. The control system of claim 11, wherein the at least one pump is configured to pump the short-term wash treatment for a time interval as defined by the second control signal.

13. The control system of claim 11, wherein the at least one pump is configured to pump the short-term intense treatment at a frequency as defined by the second control signal.

14. The control system of claim 11, wherein the at least one pump is configured to pump a particular amount of the short-term intense treatment as defined by the second control signal.

15. The control system of claim 11, wherein the second control signal is configured to cause a supply pump associated with the food-processing system to increase a flow rate of water in the food-processing system.

16. The control system of claim 9, wherein the processing system is further configured to:
receive a data input from a human machine interface (HMI), wherein the processing system is configured to generate the first control signal based on the data input and the one or more first sensor signals.

17. The control system of claim 9, wherein the interface is configured to receive feedback data from the food-processing system and wherein the processing system is configured to generate the first control signal based on the feedback data and the one or more first sensor signals.

18. The control system of claim 9, further comprising:
one or more memory devices configured to store at least one of the one or more first sensor signals or the first control signal.

19. The control system of claim 9, wherein the one or more first sensor signals comprise at least one of a first signal indicating a cutter of the food-processing system is on, a second signal indicating presence of the product on a product feed belt of the food-processing system, or a third signal indicating a speed of the product feed belt.

20. The control system of claim 9, wherein the one or more first sensor signals comprise at least one of a first signal indicating the pH in the short-term wash treatment prior to increasing the pH in the short-term wash treatment, a second signal indicating a concentration of silver ions in the short-term wash treatment, or a third signal indicating a flow rate of the short-term wash treatment to one or more applicators of the food-processing system.

21. The control system of claim 20, wherein:
the one or more first sensor signals comprise the first signal that indicates the pH of the short-term wash treatment is 2.1±0.1; and
the processing system is configured to generate the first control signal to cause the increase in the pH of the short-term wash treatment by causing the increase in the pH of the short-term wash treatment to 2.5±0.1.

22. The control system of claim 9, further comprising a dosing pump, wherein the first control signal is configured to cause the dosing pump to add sodium hydroxide (NaOH) to the short-term wash treatment.

23. The control system of claim 9, further comprising at least one sensor configured to generate the one or more first sensor signals from the food-processing system.

24. The control system of claim 9, wherein the interface is further configured to receive one or more second sensor signals from the food-processing system and wherein the processing system is further configured to:
decide, based on the one or more second sensor signals, to increase the intensity of the short-term wash treatment;
generate a second control signal to cause a decrease in the pH of the short-term wash treatment in response to the decision; and
control application of the short-term wash treatment with the decreased pH to additional product in the food-processing system.

25. The control system of claim 24, wherein the one or more second sensor signals comprise a signal indicating a speed of the product on a product feed belt of the food-processing system.

26. A non-transitory computer-readable medium for controlling a short-term wash treatment used in a food-processing system, the computer-readable medium including instructions that, when executed by a processing system, cause the processing system to perform operations comprising:
determining, based on one or more first sensor signals, to reduce an intensity of the short-term wash treatment;
increasing a pH of the short-term wash treatment in response to the determination; and
controlling application of the short-term wash treatment with the increased pH to a product in the food-processing system.
